(19) United States
(12) Patent Application Publication
(10) Pub. No.: US 2007/0035564 A1
(43) Pub. Date: Feb. 15, 2007

(54) Display processing apparatus, display processing method, and display processing program

(76) Inventor: Goro Katsuyama, Tokyo (JP)

Correspondence Address: HARNESS, DICKEY & PIERCE, P.L.C., P.O. BOX 8910, RESTON, VA, 20195, US

(21) Appl. No.: 11/494,574

(22) Filed: Jul. 28, 2006

(30) Foreign Application Priority Data
Aug. 1, 2005 (JP) 2005-223418

(51) Int. Cl. G09G 5/00

(52) U.S. Cl. 345/649

(57) ABSTRACT

A condition-display processing unit displays, in a predetermined display area, a condition specifying area in which condition information indicating a setting condition is displayed. A rotating unit rotates, when a rotation instruction is received from a user, the condition specifying area displayed by the condition-display processing unit, and rotates a next condition specifying area to the predetermined display area.

### CROSS-REFERENCE TO RELATED APPLICATIONS

The present document incorporates by reference the entire contents of Japanese priority document, 2005-223418 filed in Japan on Aug. 1, 2005.

### BACKGROUND OF THE INVENTION

1. Field of the Invention

The present invention relates to a display processing apparatus, a display processing method, and a display processing program, and, more particularly, to a technology for setting a condition on a screen.

2. Description of the Related Art

Conventionally, in apparatuses equipped with an operation panel such as an image forming apparatus, it is difficult for users to perform detailed settings they desire. It is because these apparatuses are only equipped with a screen of a minimal size necessary and only sufficient for displaying functions to users, and all settable functions have to be displayed on the screen, while an interface to be used for the setting is only equipped with a ten key, a touch panel, and the like. That is, items displayed on the screen tend to be complicated, and it is not easy for the users to select and set desired functions by the displayed items. Furthermore, the users often avoid using functions they do not understand, even if they are displayed on the screen.

Furthermore, any proposals have not been made actively with regard to the display method for improving the operability, supposedly because developers of apparatuses believe that users of apparatuses do not wish any changes of conventional user interfaces. Therefore, there are only techniques such that, in an image forming apparatus or the like, unavailable functions are not displayed on a screen, to prevent its users from trying to set the unavailable functions (see, for example, Japanese Patent Application Laid-open No. 2001-194963).

On the other hand, in a personal computer (PC) or the like, its users can select a screen size, resolution, and the like according to their needs. Accordingly, there are various techniques for displaying functions provided by software on a screen. For example, if there is a function, of which its user does not know how to use it, a help screen or the like can be easily displayed.

In addition, with regard to PCs, there is a proposed technique in which a virtual polyhedron is displayed on a desk top screen, different tools are provided for each face of the displayed virtual polyhedron, and a tool to be displayed is changed over by rotating the virtual polyhedron (see, for example, Japanese Patent Application Laid-open No. 2000-89886).

Furthermore, since the PCs include plenty of user interfaces such as a keyboard and a pointing device, users can easily set a desired function. In the invention disclosed in Japanese Patent Application Laid-open No. 2000-89886, virtual polyhedron with tools attached for each face thereof is rotated by using an interface such as a pointing device. The tools shown on the face of the virtual polyhedron can perform various types of setting as in a conventional tool window. These various types of setting can be performed only by a pointing device capable of specifying a detailed position or by a keyboard capable of inputting with various keys.

However, the technique described in Japanese Patent Application Laid-open No. 2001-194963, in which an item corresponding to an unavailable function is not displayed on the screen, only prevents its user from erroneously selecting the unavailable function. That is, there is a problem that the operability at the time of setting normal functions cannot be improved by such a display technique.

Meanwhile, it is difficult to apply the display technique provided on the PCs, which is described in Japanese Patent Application Laid-open No. 2000-89886, to image forming apparatuses or the like. It is because a monitor of the PC is designed on the assumption that its user performs various operations thereon, and hence the size of the monitor is large and capable of displaying with high resolution, which enables the use of the display technique mentioned above. In addition, while there is a trend that a liquid-crystal-display (LCD) panel is used for PC monitors to reduce its arrangement space, space-saving of an image forming apparatus or the like means that the size of a monitor on the apparatus cannot be made larger.

On the other hand, a LCD touch panel equipped on the image forming apparatus is used only when setting functions provided in the image forming apparatus, and hence the image forming apparatus only needs to have the LCD touch panel of a minimal size necessary and sufficient for displaying and setting the functions, and does not require the size and resolution as those of the PC monitor. Furthermore, since it is necessary to consider the space where the image forming apparatus is to be placed, and arrangement of other parts such as a contact glass for arranging paper document, there is a limitation in the size of the LCD touch panel that can be equipped on the image forming apparatus. This problem occurs not only in the image forming apparatus but also in equipment in which the size of a display unit is limited due to its portability or in view of its installation site.

Thus, to the apparatus in which portability, space-saving, or other functions are given priority over the size of the display unit such as the LCD touch panel, the display technique, which has been proposed on the assumption that it is used for PCs, cannot be applied.

Likewise, the equipment in which portability, space-saving, or other functions are given priority over its interface does not include many input units as in the PCs equipped with a keyboard and a pointing device. Therefore, even if the display technique proposed on the assumption of the use by the PC is applied to the equipment, it is difficult to set functions. For example, with the pointing device, a position can be specified in a unit of several dots. However, when the user selects a function by a finger on the LCD touch panel, the position cannot be specified in a unit of several dots.

### SUMMARY OF THE INVENTION

It is an object of the present invention to at least partially solve the problems in the conventional technology.

A display processing apparatus according to one aspect of the present invention includes a condition-display processing unit that displays, in a predetermined display area, a condition specifying area in which condition information indicating a setting condition is displayed; and a rotating unit that rotates, when a rotation instruction is received from a user, the condition specifying area displayed by the condition-display processing unit, and rotates a next condition specifying area to the predetermined display area.

A display processing method according to another aspect of the present invention includes displaying, in a predetermined display area, a condition specifying area in which condition information indicating a setting condition is displayed; and area rotating including rotating, when a rotation instruction is received from a user, the condition specifying area displayed at the displaying, and rotating a next condition specifying area to the predetermined display area.

A computer-readable recording medium according to still another aspect of the present invention stores therein a computer program that causes a computer to execute displaying, in a predetermined display area, a condition specifying area in which condition information indicating a setting condition is displayed; and area rotating including rotating, when a rotation instruction is received from a user, the condition specifying area displayed at the displaying, and rotating a next condition specifying area to the predetermined display area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a network diagram for explaining a network environment surrounding a multi function peripheral (MFP) according to a first embodiment of the present invention;

FIG. 2 is a block diagram of a hardware configuration of the MFP according to the first embodiment;

FIG. 3 is an example of an operation panel of the MFP;

FIG. 4 is a functional block diagram of the MFP that can execute functions of a display processing apparatus according to the first embodiment;

FIG. 5 is an example of a function selecting screen to be displayed on a LCD touch panel by a 3D-display processing unit in the MFP according to the first embodiment;

FIG. 6 is an explanatory diagram of before and after conditions of rotation control of a virtual cube by the 3D-display processing unit in the MFP according to the first embodiment;

FIG. 7 is a display example of a preview and detail setting screen to be displayed by a condition-display processing unit upon reception of selection of “Print” from a function selecting screen displayed on the LCD touch panel of the MFP according to the first embodiment;

FIG. 8 is a projection view from the front and side of the virtual cube of a virtual cube provided in a block indicating a screen combination item on the preview and detail setting screen displayed on the LCD touch panel of the MFP according to the first embodiment;

FIG. 9 is a projection view from the front and side of a virtual triangular prism provided in a block indicating a punch item on the preview and detail setting screen displayed on the LCD touch panel of the MFP according to the first embodiment;

FIG. 10 is a projection view from the front and side of a virtual pentagonal prism provided in a block indicating a density adjustment item on the preview and detail setting screen displayed on the LCD touch panel of the MFP according to the first embodiment;

FIG. 11 is an explanatory diagram of a part of a display example in which the condition-display processing unit in the MFP in an embodiment different from the first embodiment displays a face arranged at the front of the block and a part of an adjacent face of the virtual polyhedron;

FIG. 12 is an explanatory diagram of a process procedure when the setting condition of screen combination is changed on the preview and detail setting screen displayed on the LCD touch panel of the MFP according to the first embodiment;

FIG. 13 is an explanatory diagram of a shift of the screen from reception of setting for an output function “Print” until displaying the function selecting screen once again, upon reception of selection of an output function “Print” from the function selecting screen displayed on the LCD touch panel according to the first embodiment;

FIG. 14 is a display example of the preview and detail setting screen displayed when the MFP according to the first embodiment is customized and an embedding function of “Digital watermark” is added;

FIG. 15 is a flowchart of a process procedure upon reception of function selection by display on the function selecting screen in the MFP according to the first embodiment and upon reception of a setting condition of condition information displayed in the block on the preview and detail setting screen until the function selecting screen is displayed;

FIG. 16 is a display example of the preview and detail setting screen displayed on the LCD touch panel of the MFP according to a first modification example of the first embodiment;

FIG. 17 is an example of the block and the side geometry of the virtual polyhedron indicated for each item displayed by the condition-display processing unit on the preview and detail setting screen of the LCD touch panel of the MFP according to a second modification example of the first embodiment;

FIG. 18A is a display example in which the condition-display processing unit in the MFP according to a third modification example of the first embodiment provides a bar above the block for each item on the preview and detail setting screen to be displayed on the LCD touch panel;

FIG. 18B is a display example in which the condition-display processing unit according to the MFP in the third modification example of the first embodiment provides a bar for each item on the right side of the block on the preview and detail setting screen to be displayed on the LCD touch panel;

FIG. 19 is an explanatory diagram for indicating that the condition information expressed on the face is changed every time when rotation and shift of the face of the virtual cube provided in the block is displayed on the preview and detail setting screen to be displayed on the LCD touch panel by the condition-display processing unit in the MFP according to a fourth modification example of the first embodiment;

FIG. 20 is a display example of the preview and detail setting screen displayed by the condition-display processing unit upon reception of selection of “Print” in the MFP according to a fifth modification example of the first embodiment;

FIG. 21 is a projection view from the front and side of a virtual column provided in the block indicating screen combination to be displayed on the preview and detail setting screen by the condition-display processing unit in the MFP according to a sixth modification example of the first embodiment;

FIG. 22 is a functional block diagram of an MFP according to a second embodiment of the present invention;

FIG. 23 is an explanatory diagram of a display example of the preview and detail setting screen displayed on the LCD touch panel by the condition-display processing unit in the MFP according to the second embodiment;

FIG. 24 is a projection view from the front and side of a virtual cube displayed by the condition-display processing unit in the MFP according to the second embodiment;

FIG. 25 is an explanatory diagram of a shift of condition information to be displayed in a block on the preview and detail setting screen by the condition-display processing unit in the MFP according to the second embodiment;

FIG. 26 is a flowchart of a process procedure when the preview and detail setting screen is displayed on the LCD touch panel of the MFP according to the second embodiment;

FIG. 27 is an explanatory diagram of an example of a face of a virtual polyhedron arranged in the block of the LCD touch panel of the MFP according to a first modification example of the second embodiment;

FIG. 28 is an example of the preview and detail setting screen displayed by the condition-display processing unit in the MFP according to a second modification example of the second embodiment; and

FIG. 29 is a functional block diagram of a display processing apparatus according to a third embodiment of the present invention.

### DETAILED DESCRIPTION OF THE PREFERRED EMBODIMENTS

Exemplary embodiments of the present invention will be explained below in detail with reference to the accompanying drawings. According to the present embodiments, a case that the present invention is applied to an MFP, which is one type of an image forming apparatus, is explained. However, the invention is not limited thereto, and can be applied to various apparatuses that perform display processing.

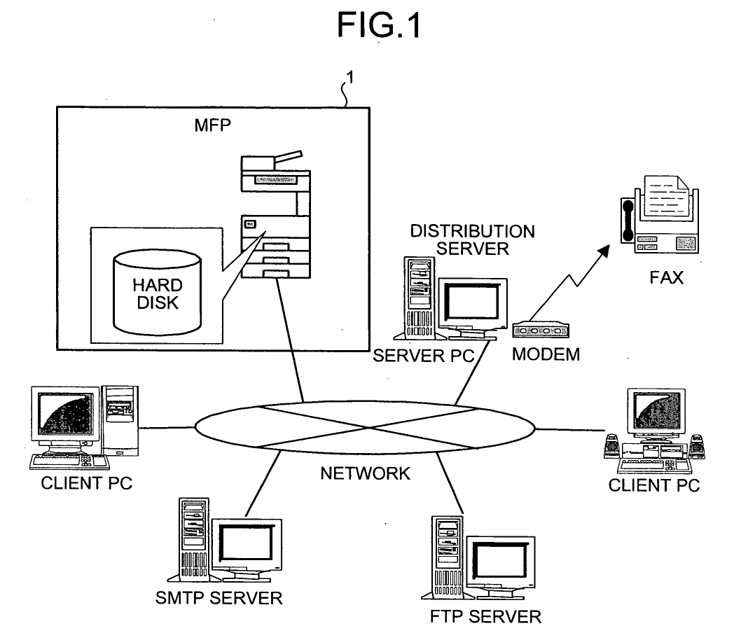

FIG. 1 is a network diagram for explaining a network environment surrounding an MFP 1 according to a first embodiment of the present invention. As shown in FIG. 1, due to recent development of networks, equipment such as a PC installed in an office or the like is connected to a network such as a local area network (LAN), so as to communicate with each other. For example, a client PC, a simple mail transfer protocol (SMTP) server, a file transfer protocol (FTP) server, and a server PC are connected to the network in FIG. 1, so that transmission/reception of e-mails and file transmission/reception can be made, and a distribution server connected to the network by a modem can communicate with a fax machine outside the office.

With the development of such a network, the MFP 1 is also connected to the network, so as to communicate with equipment such as PC, and by including a built-in memory such as a hard disk, the MFP 1 is advanced to a so-called network multifunction product, thereby satisfying various needs of users.

The MFP 1 has, in addition to a normal copy function, a printer function for printing document data and the like according to a print request from the client PC, a fax function for transmitting document data and the like to other fax machines in other offices via a modem connected to the server PC according to a fax request from the client PC, and a storage function for storing the received fax document and copied document in a built-in hard disk.

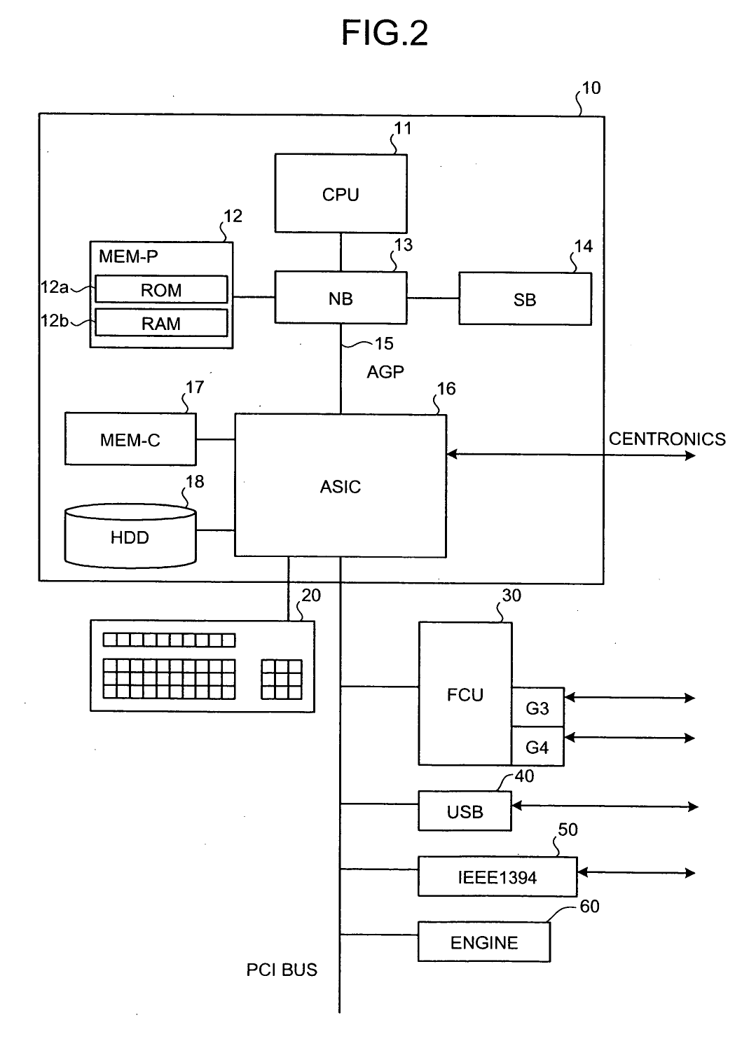

FIG. 2 is a block diagram of a hardware configuration of the MFP 1 according to the first embodiment. As shown in FIG. 2, in the MFP 1, a controller 10 is connected to an engine 60 by a peripheral component interconnect (PCI) bus. The controller 10 controls the entire MFP 1, drawing, communication, and input from an operating unit 20. The engine 60 is a printer engine or the like capable of connecting to the PCI bus, and for example, a monochrome plotter, one-drum color plotter, four-drum color plotter, scanner, or fax unit. The engine 60 includes an image processing part that performs processing such as error diffusion and gamma conversion, in addition to a so-called engine part such as a plotter. An image forming apparatus other than the MFP including the above configuration can be used as the display processing apparatus according to the first embodiment.

The controller 10 includes a central processing unit (CPU) 11, a north bridge (NB) 13, a system memory (MEM-P) 12, a south bridge (SB) 14, a local memory (MEM-C) 17, an application specific integrated circuit (ASIC) 16, and a hard disk drive (HDD) 18, and the NB 13 and the ASIC 16 are connected with each other by an accelerated graphics port (AGP) bus 15. The MEM-P 12 includes a read only memory (ROM) 12a and a random access memory (RAM) 12b.

The CPU 11 performs overall control of the entire MFP 1, includes a chip set formed of the NB 13, the MEM-P 12, and the SB 14, and is connected to other equipment via the chip set.

The NB 13 connects the CPU 11 to the MEM-P 12, the SB 14, and the AGP bus 15, and includes a memory controller that controls read and write with respect to the MEM-P 12, a PCI master, and an AGP target.

The MEM-P 12 is used as a memory for storing programs and data, a memory for expanding the program and data, a rendering memory of a printer, and the like, and includes the ROM 12a and the RAM 12b. The ROM 12a is a read only memory to be used as the memory for storing programs and data, and the RAM 12b is a writable and readable memory to be used as the memory for expanding the programs and data, the rendering memory of the printer, and the like.

The SB 14 connects the NB 13, a PCI device, and a peripheral device. The SB 14 is connected to the NB 13 via the PCI bus, and a network interface (I/F) and the like are also connected to the PCI bus.

The ASIC 16 is an integrated circuit (IC) for image processing including a hardware element for image processing, and includes a function as a bridge for respectively connecting the AGP bus 15, the PCI bus, the HDD 18, and the MEM-C 17. The ASIC 16 includes a PCI target, an AGP master, an arbiter (ARB) as a main part of the ASIC 16, a memory controller that controls the MEM-C 17, a plurality of direct memory access controllers (DMAC) that rotates image data according to a hardware logic, and a PCI unit that performs data transfer with the engine 60 via the PCI bus. A fax control unit (FCU) 30, a universal serial bus (USB) 40, and the Institute of Electrical and Electronics Engineers 1394 (IEEE 1394) interface 50 are connected to the ASIC 16 via the PCI bus.

The MEM-C 17 is a local memory to be used as an image buffer for copying and a sign buffer, and the HDD 18 is a storing unit for storing image data, programs, font data, and forms.

The AGP bus 15 is a bus interface for a graphics accelerator card proposed for speeding up the graphic processing, and by directly accessing the MEM-P 12 with a high throughput, it speeds up the graphics accelerator card.

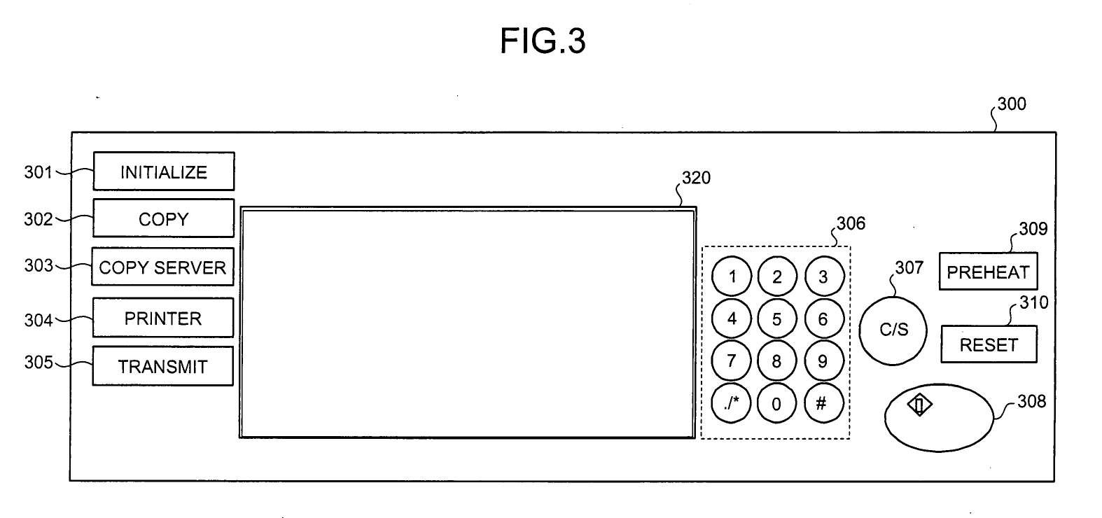

FIG. 3 is an example of an operation panel 300 in the MFP 1. As shown in FIG. 3, the operation panel 300 includes an initialize key 301, a copy key 302, a copy server key 303, a printer key 304, a transmission key 305, a ten key 306, a clear/stop key 307, a start key 308, a preheat key 309, a reset key 310, and an LCD touch panel 320. A screen, which is a feature of the present invention, is displayed on the LCD touch panel 320 (described later).

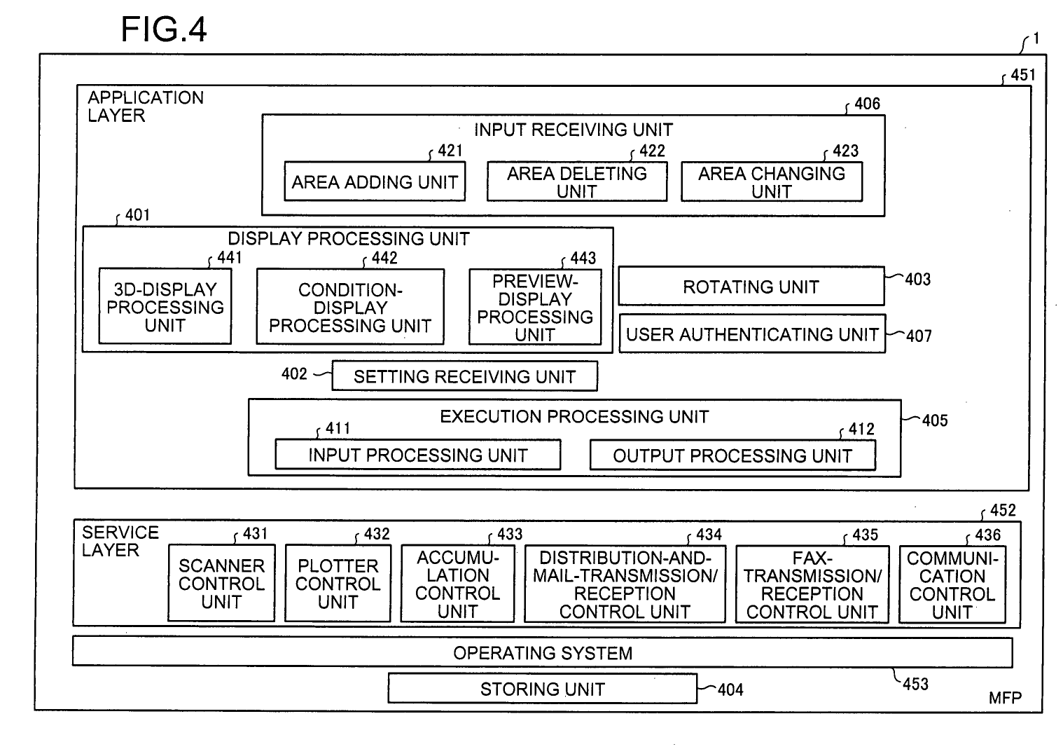

FIG. 4 is a functional block diagram of the MFP 1 that can execute the functions of the display processing apparatus according to the first embodiment. As shown in FIG. 4, the MFP 1 has a configuration including an operating system 453, a service layer 452, an application layer 451, and a storing unit 404. The display processing apparatus according to the first embodiment can be used to the image forming apparatus other than the MFP including the above configuration.

As shown in FIG. 4, the function of the MFP 1 has hierarchical relationship, and the service layer 452 is constructed above the operating system 453, and the application layer 451 including the characteristic part of the first embodiment is constructed above the service layer 452.

The operating system 453 manages resources of the MFP 1 including a hardware resource, and offers a function using the resources to the service layer 452 and the application layer 451.

The service layer 452 corresponds to a driver that controls the hardware resources included in the MFP 1. The service layer 452 controls the hardware resources included in the MFP 1 from a scanner control unit 431, a plotter control unit 432, an accumulation control unit 433, a distribution-and-mail-transmission/reception control unit 434, a fax-transmission/reception control unit 435, a communication control unit 436, and the like to execute various functions, in response to an output request from an execution processing unit 405 in the application layer 451.

The storing unit 404 stores the image data read from paper document or received by e-mail or by fax. The storing unit 404 can store data such as image data, and can be formed of a generally used storing unit such as an HDD, an optical disk, or a memory card.

The MFP 1 includes various hardware resources such as a scanner and a plotter other than the storing unit 404, although the explanation thereof is omitted.

The application layer 451 includes a display processing unit 401, a setting receiving unit 402, a rotating unit 403, the execution processing unit 405, an input receiving unit 406, and a user authenticating unit 407. The application layer 451 receives selection of either an area expressing an input function or an area expressing an output function on a screen displaying an area for each function for performing an input operation (hereinafter, “input function”) or on a screen displaying an area for each function for performing an output operation (hereinafter, “output function”) on the LCD touch panel 320, and displays a preview and detail setting screen. The preview and detail setting screen displays items settable by the function relating to the received area in a unit of predetermined rectangular area (hereinafter, the rectangular area is referred to as a block). In the block, condition information indicating installation condition for each item is displayed. The block will be described later. The MFP 1 performs processing using the input function or the output function under the setting condition according to the condition information displayed for each block.

At the time of using the MFP 1, the user authenticating unit 407 authenticates a user. As the authentication method of the user, any authentication method can be used, regardless of whether it is a technique known to the person skilled in the art. When authentication of the user is successful by the user authenticating unit 407, the MFP 1 permits the use of a predetermined function. As the function to be permitted, for example, transmission/reception of e-mail can be mentioned. User authentication by the user authenticating unit 407 is performed first, and when functions described later are to be used, it is assumed that authentication of the user has been already made.

The display processing unit 401 includes a three-dimensional (3D)-display processing unit 441, a condition-display processing unit 442, and a preview-display processing unit 443, and performs display on the LCD touch panel 320.

On the LCD touch panel 320, the 3D-display processing unit 441 displays a virtual cube holding faces on which an input function or an output function is indicated, and rotates and displays the virtual cube, centering on a predetermined axis of rotation for each predetermined period.

FIG. 5 is an example of a function selecting screen to be displayed on the LCD touch panel 320 by the 3D-display processing unit 441. The 3D-display processing unit 441 displays the virtual cube as the function selecting screen of the LCD touch panel 320. The 3D-display processing unit 441 displays a mark indicating one input function or a mark indicating one output function for each face of the virtual cube. While the mark indicating one input function or the mark indicating one output function is expressed by a character string according to the first embodiment, the function can be also displayed by a graphic symbol such as an icon, a mark, or a sign.

Furthermore, on the function selecting screen, the input receiving unit 406 detects a touch input on the face indicating the function on the LCD touch panel 320. Upon detection of a touch input of the face, the input receiving unit 406 outputs this matter to the setting receiving unit 402. As a result, the setting receiving unit 402 receives the selection of the face, for which a touch input is detected.

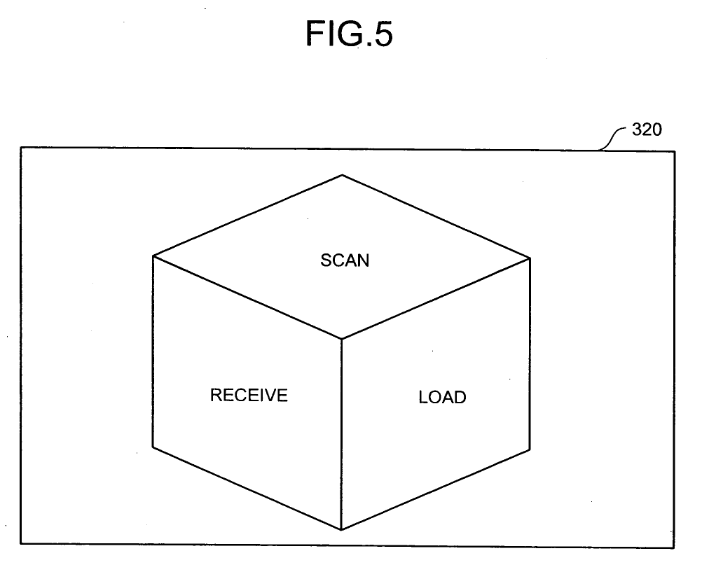

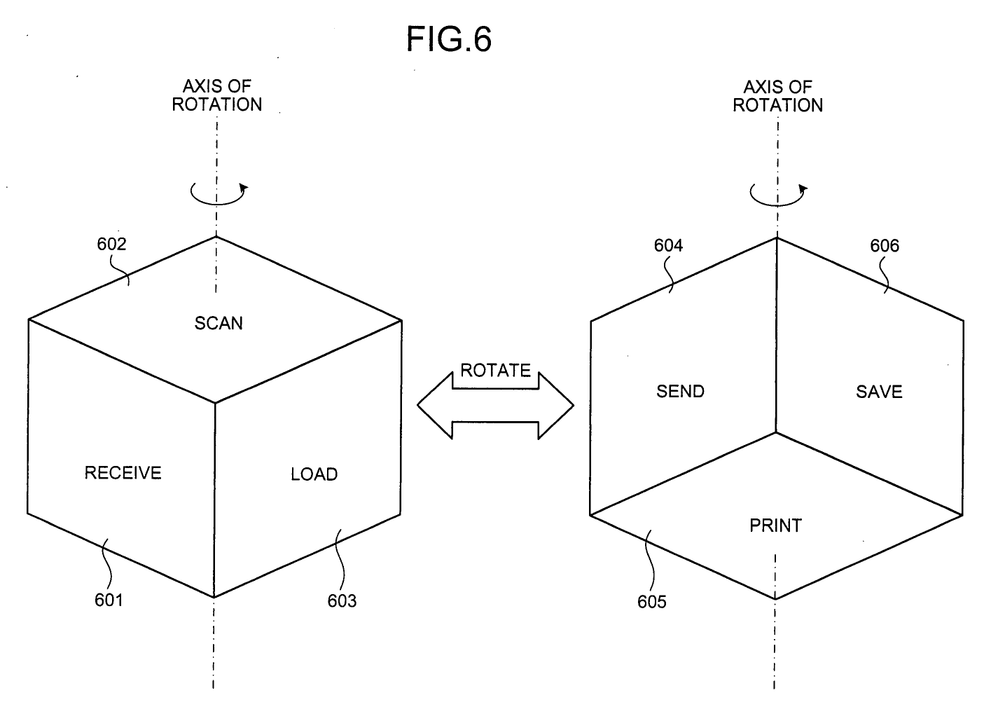

FIG. 6 is an explanatory diagram of before and after conditions of rotation control of a virtual cube by the 3D-display processing unit 441 in the MFP according to the first embodiment. As shown in FIG. 6, the 3D-display processing unit 441 changes over and displays a plurality of faces expressing the input function and a plurality of faces expressing the output function.

Specifically, the 3D-display processing unit 441 allows the virtual cube to stand still at a position where the faces expressing the input function are displayed on the LCD touch panel 320, and after 3 seconds have passed since the stop, rotates the virtual cube by half a turn, so that the virtual cube is allowed to stand still at a position where the faces expressing the output function are displayed on the LCD touch panel 320. Thereafter, the 3D-display processing unit 441 rotates the virtual cube again by half a turn in the same process procedure, to perform display such that the virtual cube is allowed to stand still at a position where the faces expressing the input function are displayed on the LCD touch panel 320. By performing such a process repetitively, the 3D-display processing unit 441 can change over the faces expressing the input function and the faces expressing the output function.

The 3D-display processing unit 441 displays a “Receive” 601, a “Scan” 602, and a “Load” 603 as the faces expressing the input function of the virtual cube. Further, the 3D-display processing unit 441 displays a “Send” 604, a “Print” 605, and a “Save” 606 as the faces expressing the output function of the virtual cube.

The “Receive” 601 enables user selection as a face expressing the input function for inputting image data received from the network. The “Scan” 602 is a face expressing the input function for scanning a paper document from an auto document feeder (ADF) equipped in the MFP 1 or inputting image data obtained by scanning a paper document arranged on the contact glass. The “Load” 603 is a face expressing the input function for reading image data stored in the storing unit 404 and inputting the data. In other words, according to the first embodiment, the face expressing the input function stands for an input instruction area.

On the other hand, the “Send” 604 is a face expressing the output function for transmitting image data to the network by e-mail or by fax, the “Print” 605 is a face expressing the output function for printing image data, and the “Save” 606 is a face expressing the output function for writing and storing image data in the storing unit 404. In other words, according to the first embodiment, the face expressing the output function stands for an output instruction area.

Furthermore, there is a predetermined relationship between the face expressing the input function and the face expressing the output function, arranged on opposite faces of the virtual cube. The predetermined relationship can be any relationship relating to the function. According to the first embodiment, it is assumed that there is a relationship such that an input source medium from which input is performed by the input function and an output destination medium to which output is performed by the output function have the same property.

For example, at the time of copying, the relationship is such that the data is read from a paper medium and printed on a paper medium, and this indicates that the scan function of the paper document expressed by the “Scan” 602 and the print function as a paper document expressed by the “Print” 605 are in the above predetermined relationship.

Furthermore, transmission/reception via the network, that is, the input function for inputting image data received from the network, expressed by the “Receive” 601, and the output function for transmitting image data via the network, expressed by the “Send” 604, are in the predetermined relationship. Further, the input function for inputting image data read from the storing unit 404, expressed by the “Load” 603, and the output function for writing image data in the storing unit 404, expressed by the “Save” 606 are in the predetermined relationship.

By recognizing the predetermined relationship, the user can easily understand the content of the function indicated on the currently displayed face based on the function indicated on the opposite face, when the virtual cube is displayed on the LCD touch panel 320, thereby improving the predictability of the function indicated on the face not currently displayed.

Further, the 3D-display processing unit 441 allows the virtual cube to rotate about the axis of rotation shown in FIG. 6 on the LCD touch panel 320. The virtual cube repeats rotation about the axis of rotation and a standstill on the LCD touch panel 320. In the stationary state, the 3D-display processing unit 441 displays such that the areas of the plurality of faces expressing the input function or the output function become substantially the same, by the axis of rotation. The axis of rotation does not penetrate an apex of a corner of the virtual cube, and penetrates the face of the virtual cube. Since the 3D-display processing unit 441 displays the cube in this manner, the areas of respective faces for receiving a selection become identical, and hence the user can easily press the respective faces.

Returning to FIG. 4, upon reception of function selection on the function selecting function, the condition-display processing unit 442 displays a block for each item on the preview and detail setting screen of the LCD touch panel 320. Faces expressing condition information held by the virtual cube are arranged so that the user can refer thereto in the blocks displayed on the preview and detail setting screen.

The items according to the first embodiment stand for items settable as setting conditions at the time of processing with a function received as a selected function. The item is not limited to an item corresponding to the function, and it can be any item for setting conditions.

The preview-display processing unit 443 displays an outline of a result of processing with the function on the preview and detail setting screen. The preview screen will be explained later.

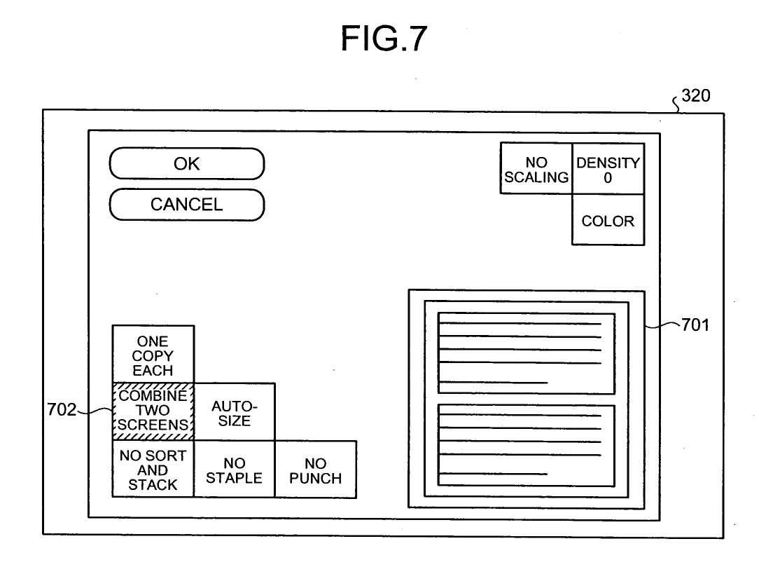

FIG. 7 is a display example of the preview and detail setting screen to be displayed by the condition-display processing unit 442 upon reception of selection of the “Print” 605 from the function selecting screen displayed on the LCD touch panel 320. As shown in FIG. 7, the condition-display processing unit 442 displays an item settable at the time of performing printing for each block. The condition-display processing unit 442 displays condition information for each item in these blocks. The user can change the condition information displayed for each item. A method for changing the condition information will be described later.

According to the first embodiment, the condition information is displayed by a character string; however, the function can be displayed by a graphic symbol such as an icon, a mark, or a sign.

For example, the condition-display processing unit 442 displays “Combine two screens” as the condition information according to an item expressing screen combination in a block 702. In other words, a condition that two screens relating to “Combine two screens” displayed in the block are combined to one screen is set. The MFP 1 then combines the two screens into one and prints it in the printing processing. Items indicated in other blocks displayed by the condition-display processing unit 442 are the same as in the screen combination.

The preview-display processing unit 443 displays an outline of a result of printing under the setting condition according to the condition information displayed in the block, in a preview 701 on the preview and detail setting screen shown in FIG. 7.

The number of sheets indicated as the result of output displayed in the preview 701 can agree with the number of sheets actually output, or the number of sheets can be abbreviated. As an example in which the number of sheets is abbreviated, there is a case that, if the number of sheets is one or two, the actual number is displayed. However, if the number of sheets is three or more, display is made such that it is only recognized that there is a plurality of sheets.

When “No punch” displayed in the block is changed to “Two holes on left”, the preview-display processing unit 443 displays a document punched at two positions on the left in the preview 701. Thus, when the setting condition for each item is changed, the preview-display processing unit 443 performs display, reflecting the changed setting condition in the preview 701. That is, by referring to the preview 701, the user can confirm the result of processing performed under the setting condition, thereby improving the convenience. Further, when the user changes the setting condition for each item, the changed item is immediately displayed in the preview 701. Therefore, even if the user does not know the content of each item, the user can intuitively understand the content of the item by changing the setting condition of each item. It is assumed here that the display in these blocks indicates a state where one face of the virtual polyhedron is expressed for each block. The virtual polyhedron is explained below.

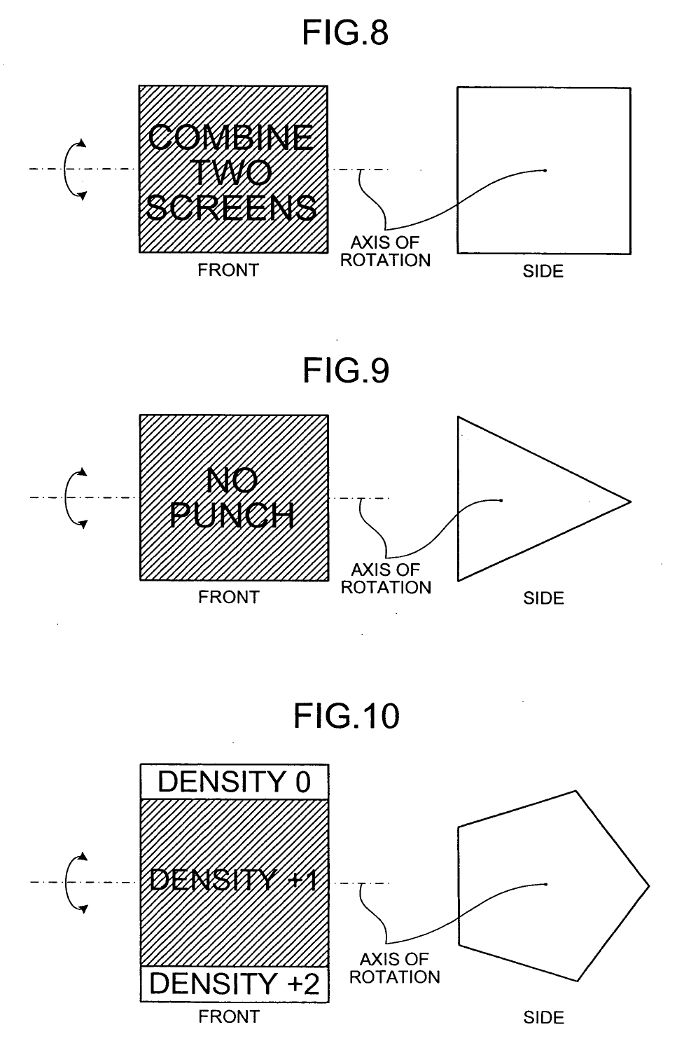

FIG. 8 is a projection view from the front and side of the virtual cube provided in a block indicating a screen combination item on the preview and detail setting screen. The condition-display processing unit 442 displays a projection view from the front of a virtual polyhedron shown in FIG. 8 in a block expressed on the LCD touch panel 320. The projection view from the side of the virtual polyhedron is prepared for facilitating the explanation. As shown in FIG. 8, a virtual cube is used as the virtual polyhedron, on the face of which condition information settable as the screen combination item is held.

The condition-display processing unit 442 displays such that the face of the virtual cube is rotated and shifted about the axis of rotation shown in FIG. 8, under the control of the rotating unit 403. The condition-display processing unit 442 stops rotation and shift when the next face expressing condition information different from that before the rotation comes to the front of the block, to display the condition information expressed on the next face arranged in the block, under the control of the rotating unit 403. In other words, different condition information is displayed every time when a different face is arranged in the block by rotating the virtual cube shown in FIG. 8. The setting receiving unit 402 receives a setting condition according to the condition information displayed on the displayed face every time when such a display by rotation and shift is performed.

According to the first embodiment, rotation and shift indicates a transition, which seems to the user that the virtual polyhedron provided in the block is rotating. In other words, so long as a transition state, which seems to the user that the virtual polyhedron is rotating, is displayed, any processing can be performed in the MFP 1.

Further, it is assumed here that the number of pieces of condition information settable for each item is different. Therefore, the MFP 1 according to the first embodiment prepares a virtual polyhedron having a different number of faces for each item. An example of the virtual polyhedron having the number of faces suitable for each item is explained.

FIG. 9 is a projection view from the front and side of a virtual triangular prism provided in a block indicating a punch item on the preview and detail setting screen. The condition-display processing unit 442 displays a projection view from the front of the virtual triangular prism shown in FIG. 9 in a block on the LCD touch panel 320. The projection from the side of the virtual polyhedron is prepared for facilitating the explanation. The virtual triangular prism shown in FIG. 9 rotates about an axis of rotation shown in FIG. 9. In the virtual triangular prism, condition information indicating a setting condition different for each face arrangeable in the block is shown. The processing performed by the setting receiving unit 402 until receiving the setting condition according to the condition information displayed on the face is the same as the screen combination item, and hence explanation thereof is omitted.

FIG. 10 is a projection view from the front and side of a virtual pentagonal prism provided in a block indicating a density adjustment item on the preview and detail setting screen. The condition-display processing unit 442 displays a projection view from the front of the virtual pentagonal prism shown in FIG. 10 in a block on the LCD touch panel 320. The projection from the side of the virtual polyhedron is prepared for facilitating the explanation. The virtual pentagonal prism shown in FIG. 10 rotates about an axis of rotation shown in FIG. 10. In the virtual pentagonal prism, condition information indicating a setting condition different for each face arrangeable in the block is shown. The processing performed by the setting receiving unit 402 until receiving the setting condition according to the condition information displayed on the face is the same as the screen combination item, and hence explanation thereof is omitted.

When a virtual polyhedron is arranged for each block on the preview and detail setting screen, the virtual polyhedrons can overlap on each other in a virtual space. However, since these virtual polyhedrons are virtual and generated taking into consideration the operability and convenience at the time of setting the setting condition for each item, it is not necessary to prepare processing when these virtual polyhedrons overlap on each other.

When displaying a virtual polyhedron, whose faces can be confirmed from the front as shown in FIG. 10, on the LCD touch panel 320, the condition-display processing unit 442 displays only the face, which comes to the front of the block. In other words, the condition-display processing unit 442 does not display the virtual polyhedron in a region protruding from the rectangular block, by equalizing the size of the rectangular block and the size of the face of the virtual polyhedron. That is, in the case of the virtual pentagonal prism shown in FIG. 10, only the face expressed as “Density +1” is displayed in the block on the LCD touch panel 320, and faces expressed as “Density 0” and “Density +2” are not at all displayed. Conceptually, it is supposed that the face of the virtual polyhedron is displayed from a window indicated by the block.

In the state that the virtual polyhedron is stationary, the condition-display processing unit 442 displays only the face, which comes to the front of the block, and upon reception of a rotation and shift instruction from the user, displays the virtual polyhedron by rotating and shifting the virtual polyhedron until the next face is displayed. Thus, by rotation and shift display, the user can recognize that a face different from the face, which was at the front previously, comes to the front. The setting receiving unit 402 then receives a setting condition according to the condition information displayed on the different face.

Returning to FIG. 4, the rotating unit 403 controls rotation and shift of the virtual polyhedron for each item indicated on the preview and detail setting screen. The rotating unit 403 controls the rotation and shift of the virtual polyhedron, and the condition-display processing unit 442 displays rotation of the virtual polyhedron about one axis of rotation horizontally as shown in FIGS. 8 to 10.

The setting receiving unit 402 receives selection of a function displayed on a face of the virtual cube on the function selecting screen displayed by the 3D-display processing unit 441. Specifically, when the user presses the face expressing the input function or the output function of the virtual cube displayed on the LCD touch panel 320 by the 3D-display processing unit 441, the setting receiving unit 402 receives this, assuming that the input function or the output function displayed on the pressed face is selected.

The setting receiving unit 402 receives the setting condition according to the condition information displayed on the face in each block on the preview and detail setting screen. That is, the setting receiving unit 402 receives the setting condition according to the condition information displayed on the face in the block, after a display of rotation of the virtual polyhedron under control of the rotating unit 403.

The condition-display processing unit 442 displays only one face for each virtual polyhedron. The shape and size of the displayed face are the same for the virtual polyhedrons having different number of faces for each item. Accordingly, in the condition-display processing unit 442, since the shape and the size of the block for each item become the same regardless of the number of faces of the virtual polyhedron, it can be prevented that the preview and detail setting screen becomes complicated. Visibility of the screen can be improved accordingly.

The present invention is not limited to a case that the face of the virtual polyhedron expressed in the block is only one as in the condition-display processing unit 442 according to the first embodiment. For example, the size of the block for each item can be made larger than the face of the virtual polyhedron, although different from the first embodiment.

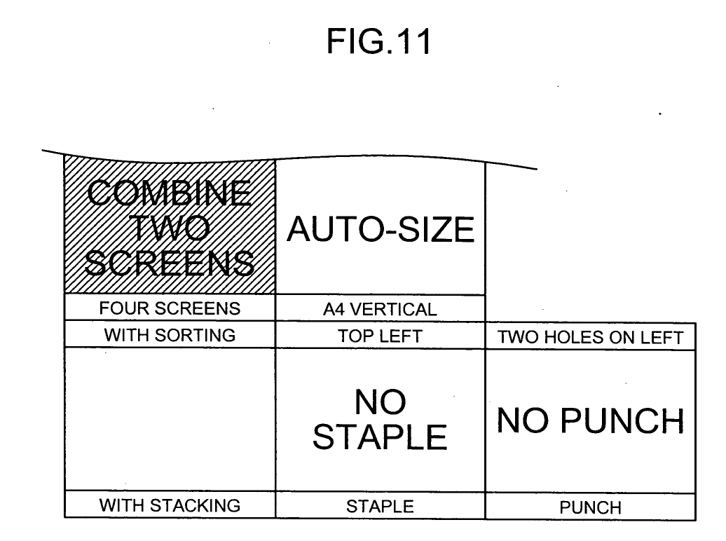

FIG. 11 is an explanatory diagram of a part of a display example in which the condition-display processing unit in the MFP according to an embodiment different from the first embodiment displays a face arranged at the front of the block and a part of an adjacent face of the virtual polyhedron. As shown in FIG. 11, condition information displayed on the front face and on the face adjacent thereto can be confirmed. The condition-display processing unit displays the adjacent face expressing condition information at the front after the virtual polyhedron is rotated and shifted by the rotating unit 403. That is, in the example shown in FIG. 11, since the condition-display processing unit displays a part of the face of the virtual polyhedron in a rotatable direction, the user can confirm the condition information on the face to be at the front next time. Accordingly, convenience at the time of operation can be improved. The display method at the time of displaying the virtual polyhedron can be one other than such a display mode, and various display modes can be made, taking users' convenience or the like into consideration.

The user presses the block for changing the condition information expressed in the block displayed on the LCD touch panel 320. When the input receiving unit 406 detects a touch input at a part above the axis of rotation on the face expressed in the block displayed on the LCD touch panel 320, the rotating unit 403 rotates and shifts the face upward, for which touch input has been detected, so that a face adjacent to the face and below thereof is shifted toward the block. The condition-display processing unit 442 displays the rotation and shift until the face below thereof comes to the front of the block. When the input receiving unit 406 detects a touch input at a part below the axis of rotation on the face displayed in the block, the rotating unit 403 rotates and shifts the face downward, for which touch input has been detected, so that a face adjacent to the face and above thereof is shifted toward the block. The rotation speed at the time of rotating and shifting the face by the rotating unit 403 can be any speed, and according to the first embodiment, at the time of display by the condition-display processing unit 442, the rotating unit 403 displays the rotation and shift at a predetermined rotation speed so that the user can recognize the rotation of the virtual polyhedron.

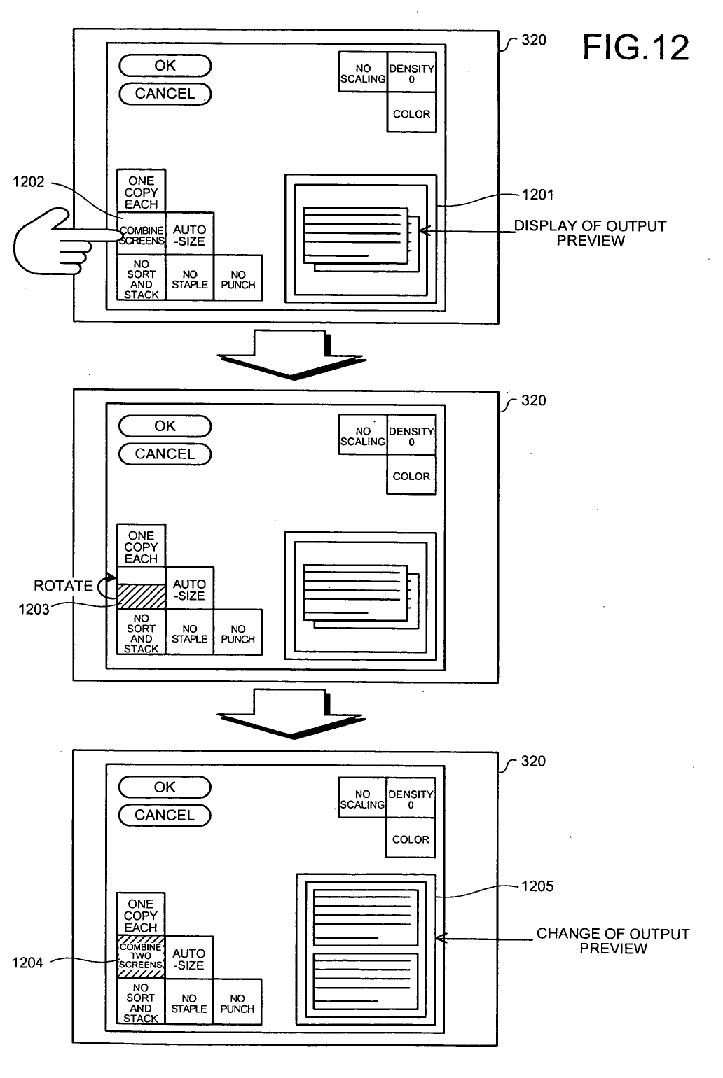

FIG. 12 is an explanatory diagram of a process procedure when the setting condition of screen combination is changed on the preview and detail setting screen displayed on the LCD touch panel. The top screen in FIG. 12 is the preview and detail setting screen displayed by the condition-display processing unit 442 and the preview-display processing unit 443 after the user presses the “Print” 605 in FIG. 6. The preview-display processing unit 443 displays in a preview 1201 a result of output of two image data already input under the received setting condition. It is assumed that the two input image data are input by using the input function shown in FIG. 6. As the input function, for example, there can be a case that a paper document is input by a scan function corresponding to the “Scan” 602.

On the preview and detail setting screen, the input receiving unit 406 detects pressing of a block for each item. The top screen in FIG. 12 depicts a state where the user presses a block 1202 indicating “Screen combination”. It is assumed here that the area pressed by the user is an upper half of the block, that is, an upper position than the axis of rotation of the virtual polyhedron expressed in the block.

When the input receiving unit 406 detects a touch input of the block on the LCD touch panel 320, the rotating unit 403 rotates and shifts the virtual polyhedron provided in the pressed block. In an example shown in FIG. 12, since the input receiving unit 406 has detected a touch input in an upper half area of the block, the rotating unit 403 rotates the virtual polyhedron so that the face arranged in the block rotates and shifts upward. A middle screen in FIG. 12 assumes that the condition-display processing unit 442 displays a rotating state of the virtual polyhedron holding the pressed face. Accordingly, the user recognizes that it seems the virtual polyhedron arranged in a block 1203 is rotating. The next face of the virtual polyhedron is then arranged in the block 1203 under the control of the rotating unit 403.

As shown in the lowest screen in FIG. 12, the preview and detail setting screen after the display of rotation and shift displays a face expressed as “Combine two screens” in a block 1204. The setting receiving unit 402 receives the setting condition relating to “Combine two screens”. As shown in the lowest screen in FIG. 12, the preview-display processing unit 443 displays a result of output according to the setting condition received in a preview 1205. Thus, the user can change the setting condition at the time of performing the processing only by pressing a block for each item. As a result, the operability is improved. In the top screen in FIG. 12, the preview-display processing unit 443 displays two image data as a result of output in the preview 1201, however, in the preview 1205 of the lowest screen in FIG. 12, image data combined to one is displayed. According to the change in the image data displayed in the preview 1205, the user can recognize the result of output under the setting condition relating to the condition information displayed on the changed face.

With regard to blocks on which items other than “Screen combination” are displayed, like the process procedure described above, a rotating state of the virtual polyhedron arranged in corresponding blocks is displayed only by the user pressing the block. Following processes are the same as the process procedure described above using the block indicating “Screen combination”, and hence explanation thereof is omitted.

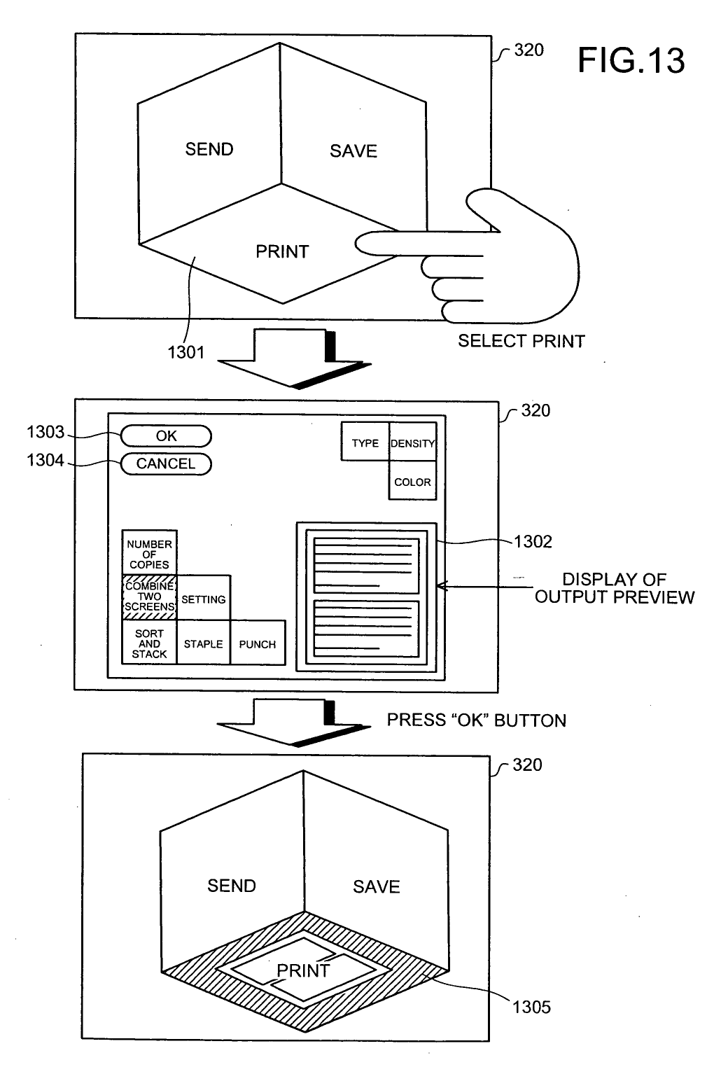

FIG. 13 is an explanatory diagram of a shift of the screen from reception of setting for an output function “Print” until displaying the function selecting screen once again, upon reception of selection of an output function “Print” 1301 from the function selecting screen according to the first embodiment. As shown in FIG. 13, when the user presses a face 1301 expressed as “Print” of the virtual cube, the input receiving unit 406 detects a touch input of the pressed face. The setting receiving unit 402 receives selection of a function relating to the face for which touch input has been detected. The condition-display processing unit 442 displays the face for which touch input has been detected in an enlarged scale, and then displays the preview and detail setting screen of the function, the selection of which has been received, on the enlarged face. The screen is shown in the middle of FIG. 13. The method until receiving the setting condition for the screen is as descried above, and hence explanation thereof is omitted.

When the user changes the setting condition for each item by pressing the face of the virtual cube expressed in the block on the screen, the setting receiving unit 402 receives the setting condition according to the condition information displayed in the block after the change. In this case, the preview-display processing unit 443 displays a result of output according to the received setting condition in a preview 1302. The user confirms the preview, and when determining that there is no problem, presses an “OK” button 1303. When the user made a mistake in selecting a function, the user presses a “Cancel” button 1304. When the input receiving unit 406 detects pressing of the “Cancel” button 1304, the setting receiving unit 402 releases the selection of function performed on the function selecting screen shown in a top part of FIG. 13. When the setting receiving unit 402 releases the selection of a function, the 3D-display processing unit 441 displays the top screen in FIG. 13 again.

When the input receiving unit 406 detects pressing of the “OK” button 1303, the 3D-display processing unit 441 displays the lowest screen in FIG. 13. The 3D-display processing unit 441 changes the color of a face 1305 expressed as “Print”, and displays a result of output by using the setting condition for each item received by the setting receiving unit 402 as a preview. By performing such a display, the user can easily recognize the result of output. In other words, the user can intuitively understand the function, as compared to color inversion or the like of the item key conventionally used, or to an explanation of function by a text. Furthermore, when selection of a face expressed as “Send” or “Save” is received, the selection can be performed in the same process procedure.

Returning to FIG. 4, the execution processing unit 405 includes an input processing unit 411 and an output processing unit 412 to perform input and output processing, using the functions included in the MFP 1. Processing by using the hardware is performed by controlling the hardware resource by the service layer 452 based on the content processed by the execution processing unit 405.

The input processing unit 411 inputs image data, using an input function, selection of which the setting receiving unit 402 has received. As a specific example, when the setting receiving unit 402 receives selection of an input function relating to the “Scan” 602, the input processing unit 411 determines it as a read function of a paper document, and reads the paper document by controlling a scanner (not shown) by the scanner control unit 431. When the setting receiving unit 402 receives selection of an input function relating to the “Receive” 601, the input processing unit 411 determines it as a reception function, and receives image data by controlling a network communication function (not shown) by the communication control unit 436. When the setting receiving unit 402 receives selection of an input function relating to the “Load” 603, the input processing unit 411 determines it as a read function from the HDD, and reads image data from the storing unit 404 provided in the MFP 1 by controlling the accumulation control unit 433, or from the HDD provided in a PC connected via the network by controlling the communication control unit 436.

The output processing unit 412 outputs image data, using an output function, selection of which the setting receiving unit 402 has received. As a specific example, upon reception of selection of an output function relating to the “Print” 605 by the setting receiving unit 402, the output processing unit 412 determines it as a print function of a paper document, and controls a plotter (not shown) by the plotter control unit 432 to print the paper document. Upon reception of selection of an output function relating to the “Send” 604 by the setting receiving unit 402, the output processing unit 412 determines it as a transmission function, and controls a network configuration function (not shown) by the communication control unit 436 to transmit the image data. Upon reception of selection of the “Save” 606 by the setting receiving unit 402, the output processing unit 412 determines it as a storage function in the HDD, and writes image data in the storing unit 404 provided in the MFP 1 by controlling the accumulation control unit 433, or in the HDD provided in the PC or the like connected via the network by controlling the communication control unit 436.

The input receiving unit 406 includes an area adding unit 421, an area deleting unit 422, and an area changing unit 423, and receives an input by the user to the operation panel 300. Specifically, the input receiving unit 406 receives a touch input to the LCD touch panel 320, assuming that the user inputs an instruction and the like. The input receiving unit 406 receives an input by the user, upon pressing of a key such as the ten key 306. When detecting a touch input in an area expressing the input function and an area expressing the output function on the function selecting screen, the input receiving unit 406 outputs this matter to the rotating unit 403. When detecting a touch input in an area corresponding to the block indicated on the detail setting screen, the input receiving unit 406 outputs this matter to the setting receiving unit 402. When a seller of the apparatus offers the MFP 1 to users, an item settable for each function can be changed by using the area adding unit 421, the area deleting unit 422, and the area changing unit 423 according to the first embodiment.

That is, in the conventional image forming apparatus, the item that can be provided for each function is displayed on the LCD touch panel 320 by providing a predetermined area. On the other hand, in the MFP 1, items that the user does not use can be provided as ones provided for each function. There is a demand to provide the image forming apparatus at a cheaper price without providing such unused items. However, when the predetermined area is provided on the LCD touch panel 320 to display each item as in the conventional apparatus, if such items are not provided, nothing is displayed in a corresponding area, and it can damage its appearance. In this case, while there is an area in which nothing is displayed on the LCD touch panel 320, a used item is displayed in a small area or necessary items are displayed over a plurality of screens. This can reduce its operability. With the screen displayed on a conventional LCD touch panel, it is troublesome and difficult to design a screen for each user in response to their requests.

Therefore, in the MFP 1 according to the first embodiment, the condition-display processing unit 442 displays an item that can be provided for each function for each block on the preview and detail setting screen. According to the first embodiment, further, the size of the block for each item is equalized. In other words, at the time of providing the MFP 1 to the user, arrangement of items for respective functions can be determined by combining blocks for items on the preview and detail setting screen. The configuration for editing the block for each item is explained below. As a result, displayed items can be changed by selecting display or non-display of the block.

The area adding unit 421 adds a block indicating condition information of an item on the preview and detail setting screen. That is, the seller can add an item for each function in response to a request from the user, thereby improving the convenience.

The area deleting unit 422 deletes a block indicating condition information of an item on the preview and detail setting screen. That is, the seller can delete an item for each function in response to a request from the user, thereby improving the convenience.

The area changing unit 423 changes arrangement of blocks indicating condition information of items on the preview and detail setting screen. That is, the seller can change the arrangement of items for each function in response to a request from the user or at the time of adding or deleting a block, thereby improving the convenience.

In the MFP 1 according to the first embodiment, the seller side can change an item to be provided for each function or arrangement of items in response to a request before or after the offer to the user, using the area adding unit 421, the area deleting unit 422, and the area changing unit 423. When the area adding unit 421, the area deleting unit 422, and the area changing unit 423 are to be used, the user authenticating unit 407 needs to authenticate whether the user is allowed to change the item to be provided. People who have such authority are, for example, maintenance persons on the seller side.

Furthermore, with the above configuration, for example, the user can delete a block of an item not required for the user by using the area deleting unit 422, and arrange a block of a different item in the vacant area by using the area changing unit 423. Thus, an item for each function can be deleted or the like in such a manner that the user does not feel it as an unnatural arrangement. When a program or the like is added in response to a request of the user, the area adding unit 421 displays a block of an item corresponding to the program on the preview and detail setting screen, thereby easily providing an item indicating a new program. That is, a block for each item can be easily edited on the preview and detail setting screen. As a result, by using the area adding unit 421, the area deleting unit 422, and the area changing unit 423, the MFP 1 can provide an item for each function corresponding to a request of the user.

Thus, by displaying the items in blocks, a screen layout for displaying only blocks of items required for the user can be easily created, and hence items corresponding to a request of the user can be easily provided. As a result, for example, by setting a fee corresponding to the items to be provided, items can be provided according to the use situation of the user, and appropriate fees can be collected corresponding to the items provided.

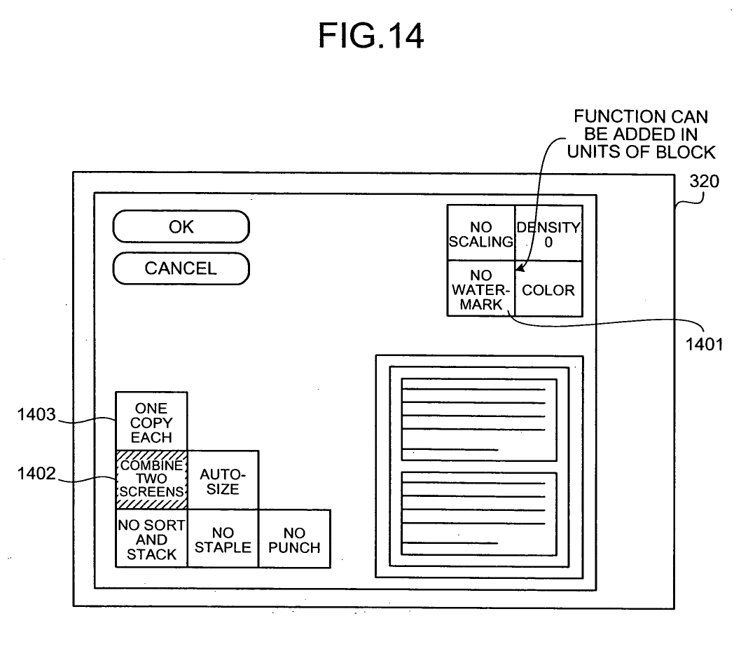

FIG. 14 is a display example of the preview and detail setting screen displayed when an embedding function of a “Digital watermark” is added. That is, before the change, the preview and detail setting screen shown in FIG. 7 is displayed. A request for adding an item for setting whether to add a digital watermark on a document has been received from a user. Therefore, a block 1401 expressing condition information of digital watermark is added by the area adding unit 421. It is assumed here that the function for embedding the digital watermark is held by the MFP 1 beforehand, and only the display of the item set for embedding the digital watermark is restricted.

As shown in FIG. 14, when a user requests to add an item, the area adding unit 421 can add a block of the requested item. In other words, when the MFP 1 adds an item in response to a request of each user, there is a problem in the layout on the screen displayed on the LCD touch panel 320. In the MFP 1 according to the first embodiment, customization is possible in a unit of block expressing the condition information of an item according to the above configuration. As a result, screen designing becomes easy. Further, when a function is to be deleted, screen designing is performed only by deleting a block indicating the function and changing the positions of blocks indicating other functions. Thus, customization of functions in the MFP 1 can be facilitated.

As another example, upon reception of a request from a user indicating that the screen combination function is not required, the area deleting unit 422 deletes a block 1402 expressing condition information of screen combination. In this case, since the area for this block becomes unoccupied, the area changing unit 423 changes the arrangement of a block 1403 expressing condition information of the number of copies to the unoccupied area. Thus, only the requested items can be displayed in an optimum arrangement on the preview and detail setting screen by using the area deleting unit 422, the area changing unit 423, and the area adding unit 421.

Since the MFP 1 according to the first embodiment has such a configuration, items can be displayed for each block on the preview and detail setting screen. Due to such display, the arrangement can be determined based on a combination of blocks. In other words, labor required for arrangement at the time displaying a plurality of items on a screen can be reduced, thereby reducing a load on a screen designer. Furthermore, since the item is expressed in a unit of block, change of positions of respective functions and addition or deletion of functions can be easily performed.

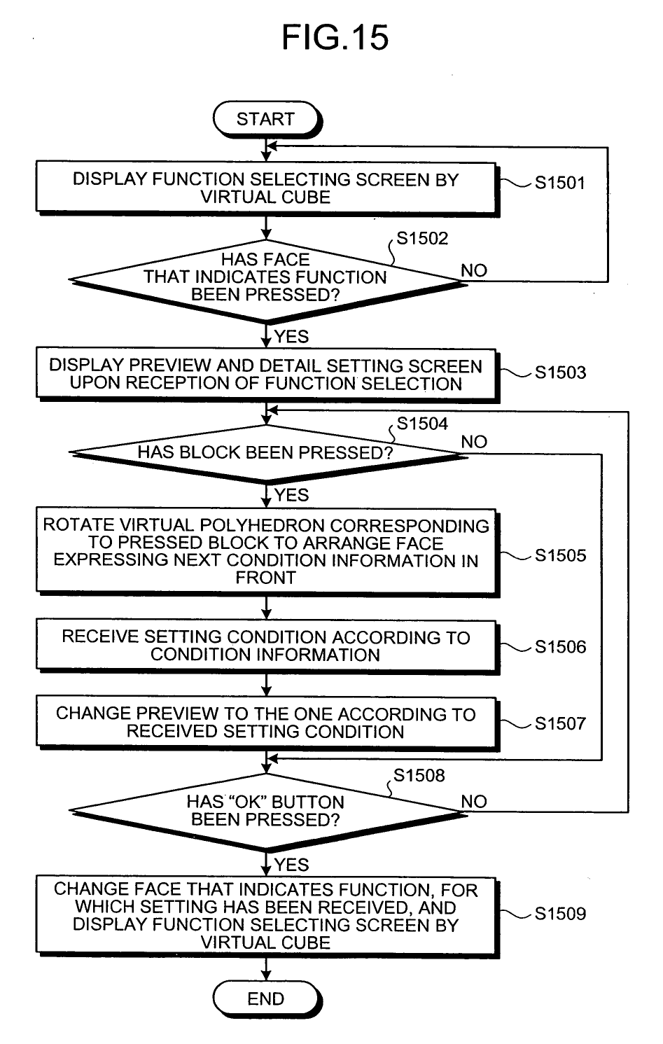

A process from reception of function selection on a display on a function selecting screen in the MFP 1 according to the first embodiment and reception of setting condition according to condition information displayed in a block on the preview and detail setting screen, until displaying the function selecting screen is explained. FIG. 15 is a flowchart of a process procedure in the MFP 1 according to the first embodiment.

The 3D-display processing unit 441 displays the function selecting screen by a virtual cube on the LCD touch panel 320 (step S1501). On the function selecting screen, marking indicating the input function and the output function is provided on each face.

The input receiving unit 406 detects whether a face expressing the input function or the output function is pressed on the LCD touch panel 320 (step S1502). When the input receiving unit 406 does not detect pressing of the face, the 3D-display processing unit 441 continuously displays the function selecting screen (step S1501). The function selecting screen is the one shown in FIGS. 5 and 6.

When the input receiving unit 406 detects pressing of the face on the function selecting screen, the condition-display processing unit 442 displays blocks for respective items on the preview and detail setting screen of the function corresponding to the face, of which pressing has been detected (step S1503). At the same time, the preview-display processing unit 443 displays an outline of result of processing under a predetermined setting condition in a preview on the preview and detail setting screen. The preview and detail setting screen is the one shown in, for example, FIG. 7. The display processing unit 401 further displays “OK” button and “CANCEL” button.

The input receiving unit 406 then detects pressing of a block expressing condition information of the item on the preview and detail setting screen (step S1504). When the input receiving unit 406 does not detect pressing of the block (step S1504: No), no particular process is performed.

When the input receiving unit 406 detects pressing of the block (step S1504: Yes), the rotating unit 403 rotates and shifts the virtual polyhedron corresponding to the block, of which pressing has been detected, until the face expressing the next condition information comes to the block (step S1505).

The setting receiving unit 402 receives the setting condition according to condition information of the face displayed in the block (step S1506). The preview-display processing unit 443 then displays a preview of a result of processing under the received setting condition (step S1507).

The input receiving unit 406 detects whether the “OK” button has been pressed on the preview and detail setting screen displayed on the LCD touch panel 320 (step S1508). When the input receiving unit 406 does not detect pressing of the “OK” button (step S1508: No), the input receiving unit 406 detects once again whether a block expressing condition information of an item has been pressed (step S1504).

When the input receiving unit 406 detects pressing of the “OK” button (step S1508: Yes), the 3D-display processing unit 441 changes the color of the face corresponding to the function, for which setting has been received in the above process, and displays a preview of a result of processing under the setting condition received on the preview and detail setting screen on the face corresponding to the function (step S1509).

According to the above process procedures, the user can set the setting condition for each item of functions used for input and output, and confirm the result of processing under the setting condition in the preview. The process procedure indicates one example of processing from initial display of the function selecting screen until display of the function selecting screen after having received the function selection, and the present invention is not limited thereto.

According to the first embodiment, the face of the virtual polyhedron and the shape of the block are rectangular. However, these are not limited to rectangle, and any shape such as hexagon can be used.

In the MFP 1 according to the first embodiment, when a user presses a block expressing condition information for each item on the preview and detail setting screen of the LCD touch panel 320, after the rotating unit 403 rotates the virtual polyhedron arranged in the pressed block, the condition-display processing unit 442 displays in the block a face expressing condition information different from that expressed by the face before the rotation, and the setting receiving unit 402 receives the setting condition according to the displayed condition information. As a result, convenience and operability at the time of setting the condition for each item on the preview and detail setting screen is improved.

When the preview and detail setting screen is displayed on the LCD touch panel 320, a display area for each item becomes the size of the block. Accordingly, according to the first embodiment, the display areas for respective items have the same size, although the display area has a different size for each item due to the number of settable conditions in the conventional display method. As a result, layout design and change at the time of display on the preview and detail setting screen become easy. If any setting has not been received, the condition information is not displayed, and hence the size of the display area for each item becomes smaller than in the conventional display method. As a result, the display area of the LCD touch panel 320 can be effectively used.

According to the first embodiment, the condition-display processing unit 442 displays the face of the virtual polyhedron for each block. However, it is not a matter of question if the condition-display processing unit 442 actually holds the virtual polyhedron for each block. That is, even if the condition-display processing unit 442 does not hold the virtual polyhedron, if the faces of the virtual polyhedron are displayed to the user as if the virtual polyhedron is rotating for each block, the user supposes that the polyhedron having the rotated faces is provided in the block. As a result, the user can understand the condition information for each item three-dimensionally, thereby obtaining the above effect. In other words, it is important that the polyhedron looks like rotating, and the condition-display processing unit 442 does not need to actually hold the virtual polyhedron and control rotation thereof.

The first embodiment is not limited to a case that after the rotating unit 403 rotates the virtual polyhedron, the setting receiving unit 402 receives a condition according to condition information expressed on the face arranged in the block. For example, after the rotating unit 403 rotates the virtual polyhedron, when an input indicating a decision of condition information expressed on the face of the virtual polyhedron arranged in the block on the LCD touch panel 320 is received from a user on the operation panel 300 by using the start key 308, the setting receiving unit 402 can receive a condition according to the condition information expressed on the face arranged in the block. Thus, reception of the condition according to condition information expressed on the face arranged in the block can be based on any condition.

Further, the operation can be performed by using user's voice. For example, while the preview and detail setting screen is being displayed, when a configuration for detecting a voice instruction detects a keyword instructing rotation for each block from a user, the rotating unit 403 rotates the virtual polyhedron arranged in the block corresponding to the keyword. The condition-display processing unit 442 then displays rotation and shift of the face of the virtual polyhedron, and when a face of the virtual polyhedron expressing the condition information comes to the block, the condition information is read from a speaker equipped on the MFP 1. The condition-display processing unit 442 displays the result of processing using the setting condition in the condition information in the preview. When the user says a keyword for stopping such as “stop”, the configuration for detecting a voice instruction detects the keyword, the rotating unit 403 controls the condition-display processing unit 442 to stop the rotation, and the setting receiving unit 402 receives the setting condition according to the displayed condition information.

On the preview and detail setting screen of the MFP 1 according to the first embodiment, the condition-display processing unit 442 displays only the face of the virtual polyhedron provided in the block, at the time of displaying the virtual polyhedron expressing condition information for each item. However, the display of the virtual polyhedron is not limited to the display of the face thereof. For example, information indicating the number of faces of the virtual polyhedron expressing the condition information, or information that makes the user understand which face is currently being displayed among all faces of the virtual polyhedron expressing the condition information can be displayed. Therefore, according to a first modification example of the first embodiment, a case that the condition-display processing unit displays a projection view, which projects the virtual polyhedron from the side, on the preview and detail setting screen is explained. Since the condition-display processing unit displays a side geometry of the virtual polyhedron, the correspondence between the face of the virtual polyhedron currently arranged in the block and the faces held by the virtual polyhedron becomes clear.

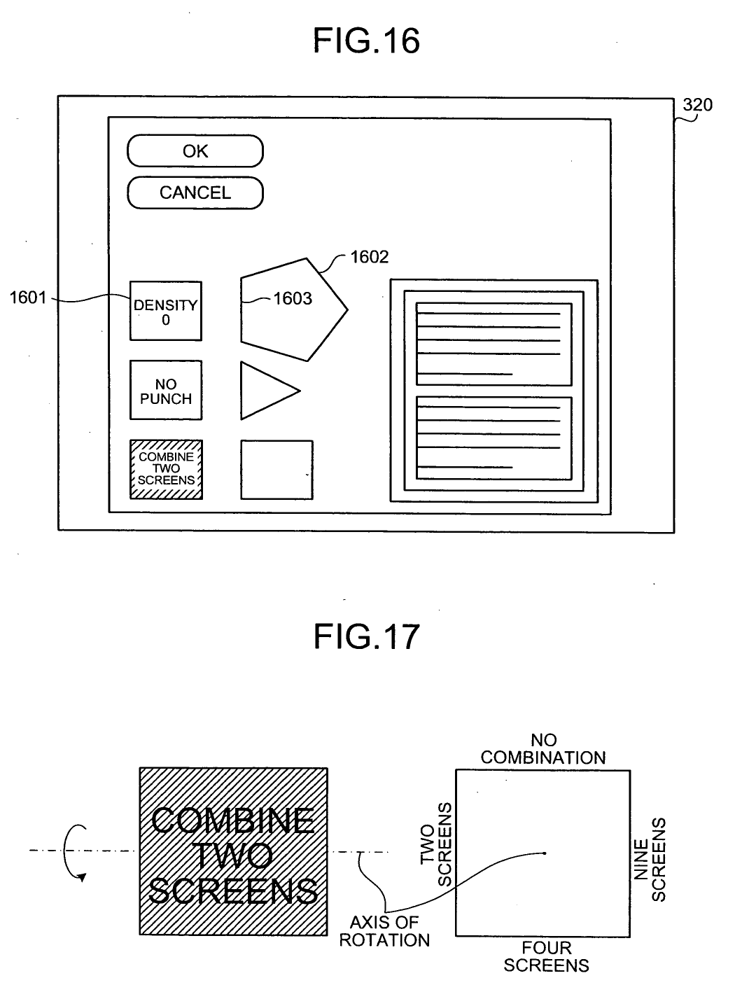

FIG. 16 is a display example of the preview and detail setting screen displayed on the LCD touch panel 320 according to the first modification example. The condition-display processing unit according to the first modification example displays the side geometry of the virtual polyhedron for each settable item. For example, a regular pentagon 1602 has a side geometry of the virtual polyhedron arranged in a block 1601 expressed as “Density 0”. A side 1603 thereof corresponds to the face arranged in the block.

When the input receiving unit 406 detects pressing of a block for an item by a user, the condition-display processing unit displays rotation of the regular pentagon 1602 having the side geometry of the virtual polyhedron arranged at the side of the block, synchronously with the control of rotation of the virtual polyhedron provided in the block by the rotating unit. Accordingly, the user can easily understand that the virtual polyhedron is rotating. In the first modification example, since the condition-display processing unit displays the side geometry of the virtual polyhedron, the user can understand the number of faces expressing the condition information provided on the virtual polyhedron. That is, the user can recognize the number of condition information settable for each item, thereby improving the convenience. If the condition information has been already displayed, the user can understand which is the face expressing the condition information by displaying the side geometry. That is, the operation procedure for displaying already displayed condition information becomes clear. Accordingly, the operability at the time of setting the condition information is improved.

### Second Modification Example of First Embodiment

In the first modification example of the first embodiment, an example in which the side geometry of the virtual polyhedron is displayed for each item on the preview and detail setting screen is explained. However, the present invention is not limited to the display of the side geometry at the time of displaying the virtual polyhedron for each item on the preview and detail setting screen. Therefore, according to a second modification example of the first embodiment, a case that the condition-display processing unit displays condition information for each face indicated by the side geometry at the time of displaying the side geometry of the virtual polyhedron is explained.

In the second modification example, on the preview and detail setting screen displayed on the LCD touch panel 320, blocks for respective items and the side geometry of the virtual polyhedron for each item are displayed, as in the display example of the preview and detail setting screen shown in FIG. 16 in the first modification example. As a feature different from the display example shown in FIG. 16, the condition-display processing unit in the second modification example displays the condition information on each face of the side geometry of the virtual polyhedron displayed on the screen.

FIG. 17 is an example of the block and the side geometry of the virtual polyhedron indicated for each item displayed by the condition-display processing unit on the preview and detail setting screen of the LCD touch panel 320 in the second modification example. The condition-display processing unit displays condition information of an item in the block, and displays condition information for each face of the side geometry of the virtual polyhedron. Since the condition-display processing unit performs such a display, the user can recognize the settable condition information and the position of the face expressing condition information desired by the user at the time of setting the setting condition for each item. Accordingly, the convenience and operability at the time of setting the condition for each item by the user can be improved.

### Third Modification Example of First Embodiment

In the first and second modification examples of the first embodiment, the user can recognize the number of settable conditions and the position of the face currently arranged in the block on the virtual polyhedron by displaying the side geometry of the virtual polyhedron. However, the present invention is not limited to the display of the side geometry of the virtual polyhedron, so long as the number of settable conditions and the position of the face currently arranged in the block on the virtual polyhedron can be recognized by the user. Therefore, according to a third modification example of the first embodiment, an example is explained such that a bar for allowing the user to recognize the number of settable conditions and the position of the face currently arranged in the block on the virtual polyhedron is displayed on the preview and detail setting screen.

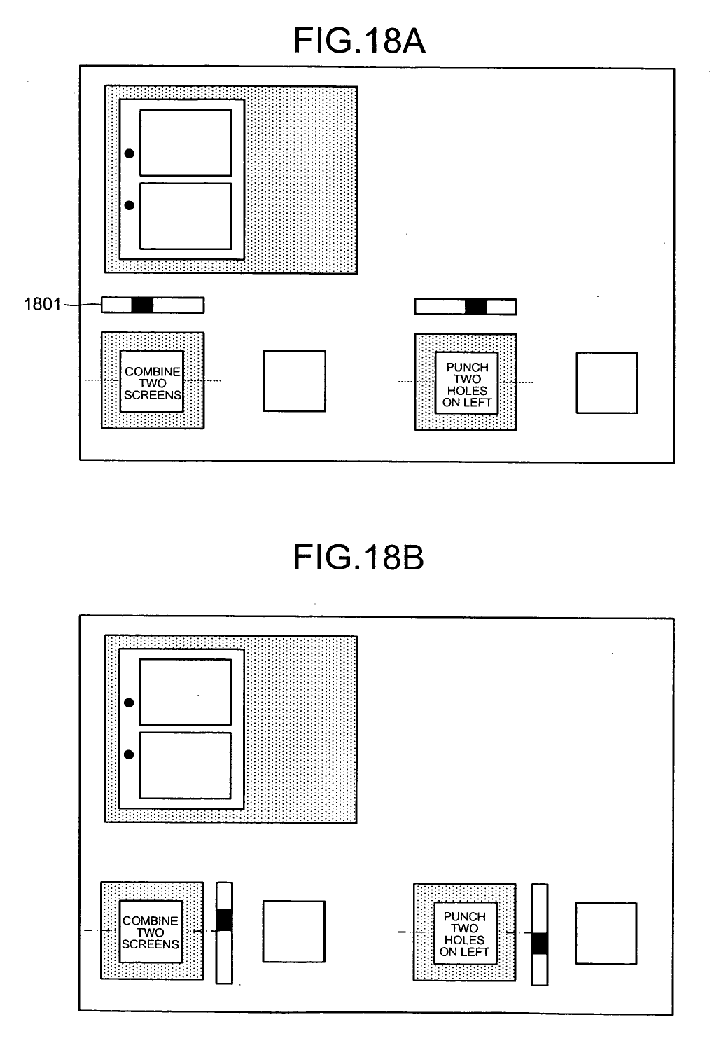

FIG. 18A is a display example of the preview and detail setting screen to be displayed on the LCD touch panel 320 by the condition-display processing unit in the third modification example. As shown in FIG. 18A, the condition-display processing unit displays a preview of the result of processing, the block for each item, and the side geometry on the preview and detail setting screen, as in the first and second modification examples of the first embodiment. The condition-display processing unit also displays a bar above the block of each item. The displayed bar indicates the number of settable conditions for each item, and the position of the face currently displayed. As a result, the user can easily recognize the number of conditions and the position of the displayed face. Specifically, a bar 1801 indicates a bar for the item of the screen combination. A part painted in black of the bar 1801 indicates the position of “Combine two screens” currently displayed. From the whole area of the bar and the area of the part painted in black, the number of settable condition information can be recognized. Synchronously with the rotation and shift of the face of the virtual polyhedron provided in the block by the rotating unit, the condition-display processing unit displays a change of the position of the part of the bar painted in black. Accordingly, the user can recognize the position of the face currently displayed, thereby improving the convenience at the time of operation.

At the time of display by the condition-display processing unit, the arrangement of the bar for each item is not limited to above the block. FIG. 18B is a display example in which the condition-display processing unit provides the bar for each item on the right side of the block on the preview and detail setting screen. Even when the bar is arranged in this manner, the user can recognize the number of settable condition information and the position of the face currently displayed.

In the third modification example, the condition-display processing unit displays the bar and the side geometry of the virtual polyhedron in addition to the block, as the display for each item on the preview and detail setting screen. However, the condition-display processing unit can display only the block and the bar as the display for each item, without displaying the side geometry.

### Fourth Modification Example of First Embodiment

In the first to third modification examples of the first embodiment, fixed condition information is arranged at all times on each face of the virtual polyhedron on the preview and detail setting screen displayed by the condition-display processing unit. That is, the condition information displayed on a predetermined face is the same at all times. However, the present invention is not limited to the case that static condition information is held on each face. For example, when the number of faces held by the virtual polyhedron that can be arranged in a block is four, the condition information to be displayed is not limited to four. The condition-display processing unit can display more pieces of condition information or less. In a fourth modification example of the first embodiment, therefore, a case that the condition-display processing unit dynamically changes and displays condition information expressed on the face of the virtual polyhedron, every time when the rotating unit controls rotation of the virtual polyhedron, is explained.

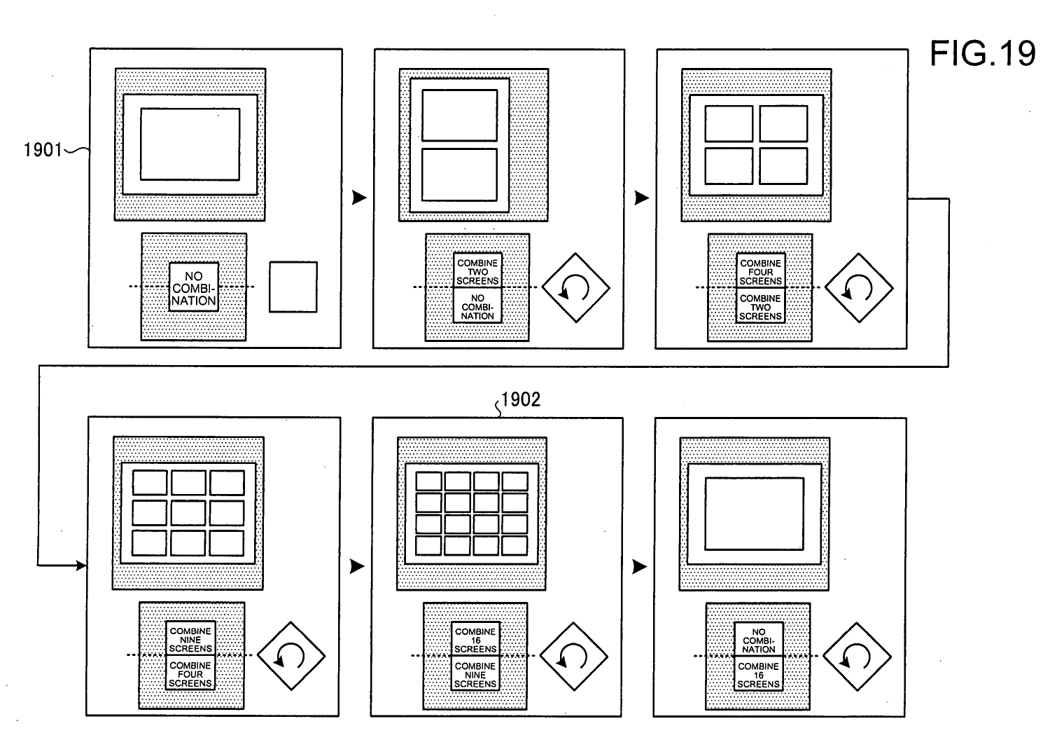

FIG. 19 is an explanatory diagram for indicating that the condition information expressed on the face is changed every time when rotation and shift of the face of the virtual cube provided in the block is displayed on the preview and detail setting screen to be displayed on the LCD touch panel 320 by the condition-display processing unit in the fourth modification example. Since a virtual cube is used as the virtual polyhedron, when the condition-display processing unit displays changes four times, the same face is then displayed again. The condition-display processing unit first displays a preview and detail setting screen 1901. After displaying rotation and shift four times in the same direction, the condition-display processing unit displays a preview and detail setting screen 1902. Thus, in the fourth modification example, the condition-display processing unit displays different condition information, although on the same face. Since the condition-display processing unit performs such a display, even when there are many pieces of condition information settable for each item, it is not necessary to use a virtual polyhedron having the same number of faces as the number of condition information to perform display. Accordingly, processing by the MFP 1 is reduced. Furthermore, even when the number of settable condition information is different, the same virtual polyhedron can be used for each item, thereby facilitating development.

In FIG. 19, the side geometry of the virtual polyhedron is displayed for easy understanding. However, the user normally supposes that the same condition information is held on the same face. To prevent the user from supposing this way, it is desired that the condition-display processing unit does not display the side geometry of the virtual polyhedron on the preview and detail setting screen.

The condition-display processing unit can display a bar for each item shown in the third modification example of the first embodiment, in order to display settable condition information for each item on the LCD touch panel 320 in the fourth modification example. Note that the condition-display processing unit displays the bar so that the user can recognize the settable number of condition information, not the number of faces.

### Fifth Modification Example of First Embodiment

In the first to fourth modification examples of the first embodiment, upon reception of selection of output function, the preview-display processing unit displays output result summary obtained by using the selected output function as a preview on the preview and detail setting screen. However, the display is not limited to the preview of the output result on the preview and detail setting screen displayed by the preview-display processing unit. For example, the condition-display processing unit can display a preview of input result summary. In a fifth modification example, therefore, a case that, upon reception of selection of output function, the condition-display processing unit displays a preview of the output result summary and a preview of the input result summary, together with a block for each item to be used for the output function on the preview and detail setting screen is explained. Other screens and the process procedure are the same as according to the first embodiment, and hence explanation thereof is omitted.

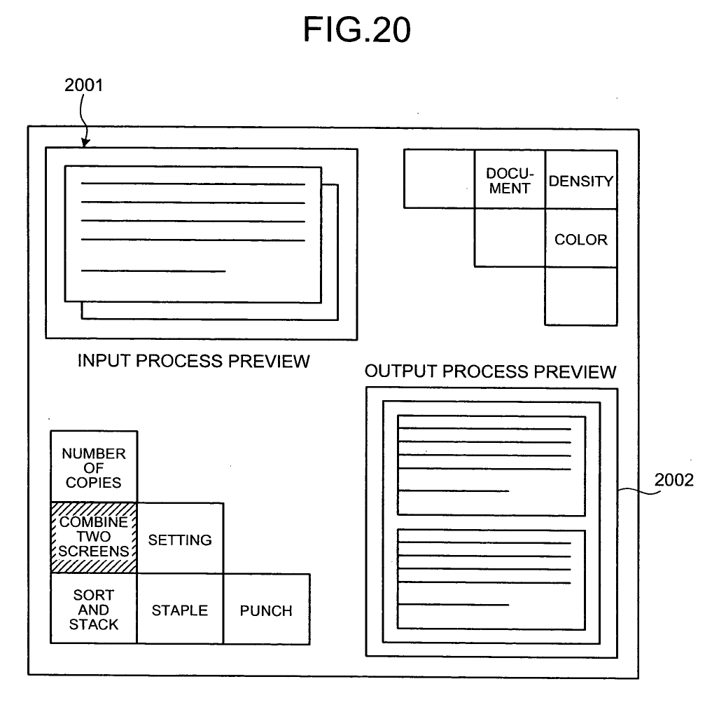

FIG. 20 is a display example of the preview and detail setting screen displayed by the condition-display processing unit and the preview-display processing unit, upon reception of selection of “Print”. The preview-display processing unit displays an input process preview 2001 indicating the input result summary on a top left area on the screen, and displays an output process preview 2002 indicating the output result summary on a lower right area on the screen. As according to the first embodiment, the condition-display processing unit then displays various items for setting detailed setting conditions around the preview screens in a unit of block.

Upon pressing of an optional block by the user, the rotating unit controls rotation of the virtual polyhedron arranged in the block, and then the condition-display processing unit displays a face expressing condition information different from that before the rotation and shift. In this case, the setting receiving unit 402 newly receives setting condition according to the condition information expressed in the block. As a result, new setting condition for the concerned item can be received upon pressing of the block by the user. The preview-display processing unit then displays the output result obtained by using the newly received setting condition for the concerned item in the output process preview 2002. Accordingly, the user can recognize the output result before actual output. At this time, the user can compare input image data in the input process preview 2001 with image data indicating the output result in the output process preview 2002. As a result, the user can visually understand what kind of setting has been received for the output processing. Thus, since the user can set setting condition for each item shown in the block, the operability is improved. Further, since the input processing result and the output processing result can be compared with each other in the preview, the convenience is improved.

### Sixth Modification Example of First Embodiment

According to the first embodiment, as the virtual polyhedron provided in the block, a polygonal prism or a regular polyhedron is used; however, the shape thereof is not limited thereto. Therefore, in a sixth modification example, a case that a column is used as the virtual polyhedron is explained.

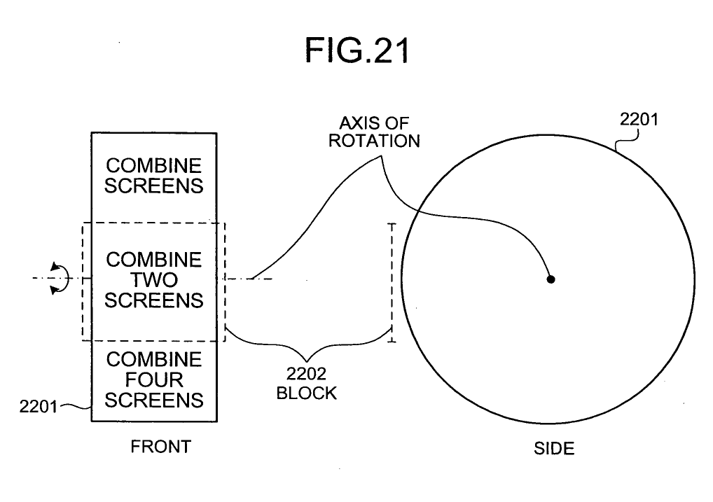

FIG. 21 is a projection view from the front and side of a virtual column provided in the block indicating screen combination to be displayed on the preview and detail setting screen displayed on the LCD touch panel in the MFP according to the sixth modification example. In the projection view from the front, the condition-display processing unit displays condition information of a virtual column 2201 expressed in a frame of a block 2202, in a block on the preview and detail setting screen of the LCD touch panel. The projection view from the side of the virtual polyhedron is prepared for easy explanation, and the user cannot refer to the diagram. The virtual column shown in FIG. 21 rotates about an axis of rotation shown in the drawing. Condition information is expressed on the column for each of a predetermined side area. The setting receiving unit receives setting condition according to condition information displayed in the block. This process is the same as that of the first embodiment, and hence explanation thereof is omitted. In other words, the same effect as that of the first embodiment can be obtained, thereby improving the convenience and operability.

### Second Embodiment

According to the first embodiment, one axis of rotation is provided for each virtual polyhedron provided in the block. However, the number of axis of rotation for each virtual polyhedron is not limited. Further, the present invention is not limited to a case that the virtual polyhedron is prepared for each item, and a plurality of items can be coordinated on one virtual polyhedron. Therefore, in a second embodiment of the present invention, a case that all settable items are coordinated on one virtual polyhedron, and the rotation of the virtual polyhedron in a plurality of directions is controlled by using a plurality of axis of rotation is explained.

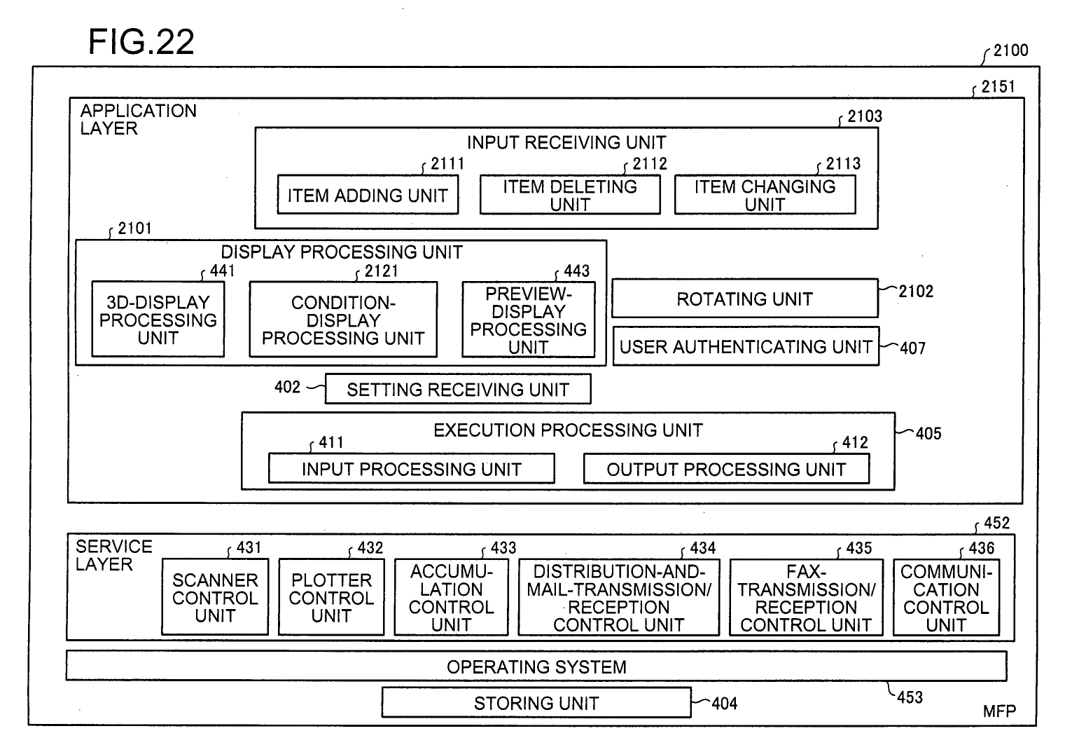

FIG. 22 is a functional block diagram of an MFP 2100 according to the second embodiment. The MFP 2100 is different from the MFP 1 according to the first embodiment in that it includes a display processing unit 2101 including a different process from that of the display processing unit 401, a rotating unit 2102 including a different process from that of the rotating unit 403, and an input receiving unit 2103 including a different process from that of the input receiving unit 406. In the explanation below, like reference numerals refer to like parts as according to the first embodiment, and explanation thereof is omitted.

The display processing unit 2101 includes the 3D-display processing unit 441, a condition-display processing unit 2121, and the preview-display processing unit 443, and performs display on the LCD touch panel 320.

The condition-display processing unit 2121 displays the preview and detail setting screen on the LCD touch panel 320 upon reception of function selection on the function selecting screen. The condition-display processing unit 2121 displays one block on the preview and detail setting screen. One virtual polyhedron is provided in one block.

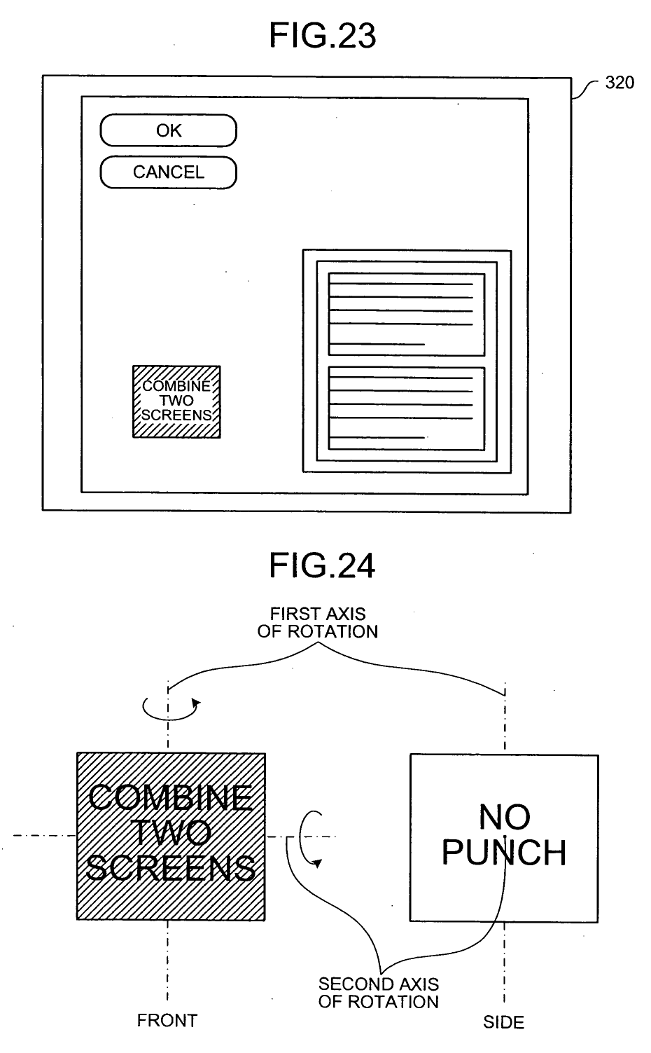

FIG. 23 is an explanatory diagram of a display example of the preview and detail setting screen displayed on the LCD touch panel 320 by the condition-display processing unit 2121 according to the second embodiment. As shown in FIG. 23, the condition-display processing unit 2121 displays one block on the screen. The preview-display processing unit 443 displays a preview of a result of processing. The display processing unit 2101 displays an “OK” button and a “cancel” button. The setting condition can be set for a plurality of items in the block. The setting method is explained later. After the rotating unit 2102 controls rotation of the virtual polyhedron in the block as according to the first embodiment, when the condition-display processing unit 2121 displays condition information different from that of before the rotation, the setting receiving unit 402 receives the setting condition according to the condition information. The preview-display processing unit 443 displays a preview of a result of processing by using the received setting condition.

FIG. 24 is a projection view from the front and side of a virtual cube displayed by the condition-display processing unit 2121 according to the second embodiment. The condition-display processing unit 2121 displays the projection view from the front of the virtual cube shown in FIG. 24 on the LCD touch panel 320. The projection view from the side of the virtual cube is prepared for easy explanation. A virtual cube is used as the virtual polyhedron in the second embodiment. The virtual cube includes two rotation axes perpendicular to each other as the axis of rotation to be used when the condition-display processing unit 2121 displays rotation and shift of the face of the virtual cube. That is, after the rotating unit 2102 controls rotation of the virtual cube about the first axis of rotation, the condition-display processing unit 2121 displays in the block a face on which the condition information of an item different from that of before the rotation is expressed. After the rotating unit 2102 controls rotation of the virtual cube about the second axis of rotation, the condition-display processing unit 2121 displays in the block a face on which different condition information of the same item as that of before the rotation is expressed. Accordingly, the condition information displayed on the face of the virtual cube displayed by the condition-display processing unit 2121 is dynamically changed corresponding to the rotation direction and displayed.

Returning to FIG. 22, the rotating unit 2102 controls rotation of the one virtual cube arranged in the block on the preview and detail setting screen by using the two orthogonal rotation axes. Accordingly, the rotating unit 2102 rotates and shifts the face arranged in the block, and rotates and shifts another face toward the block. Specifically, when controlling rotation of the virtual polyhedron by using the first axis of rotation, the rotating unit 2102 controls rotation and shift of the virtual polyhedron until a face expressing the condition information of the item different from that of before rotation comes to the block. When controlling rotation of the virtual polyhedron by using the second axis of rotation, the rotating unit 2102 controls rotation and shift of the virtual polyhedron until a face expressing different condition information of the same item as that of before rotation comes to the block. The condition-display processing unit 2121 displays the rotation and shift by the rotating unit 2102 on the LCD touch panel 320.

The rotating unit 2102 controls the condition-display processing unit 2121 upon reception of touch input of the block from the input receiving unit 2103. For example, the input receiving unit 2103 divides the block into top and bottom regions, and left and right regions, and detects pressing of each region. When pressing of the left region of the block is detected, the input receiving unit 2103 outputs this matter to the rotating unit 2102. When it is input that pressing of the left region is detected, the rotating unit 2102 rotates the virtual cube leftward by using the first axis of rotation, thereby rotating and shifting the right side face of the block toward the block. Further, when it is input that pressing of the right region of the block is detected, the rotating unit 2102 rotates the virtual cube rightward by using the first axis of rotation. When it is input that pressing of the top region of the block is detected, the rotating unit 2102 rotates the virtual cube upward by using the second axis of rotation. When it is input that pressing of the lower region of the block is detected, the rotating unit 2102 rotates the virtual cube downward by using the second axis of rotation. The rotation speed at the time of rotating and shifting the face by the rotating unit 2102 can be any speed, and in the second embodiment, the rotating unit 2102 controls rotation of the virtual polyhedron at a predetermined rotation speed at which the user can recognize the rotation.

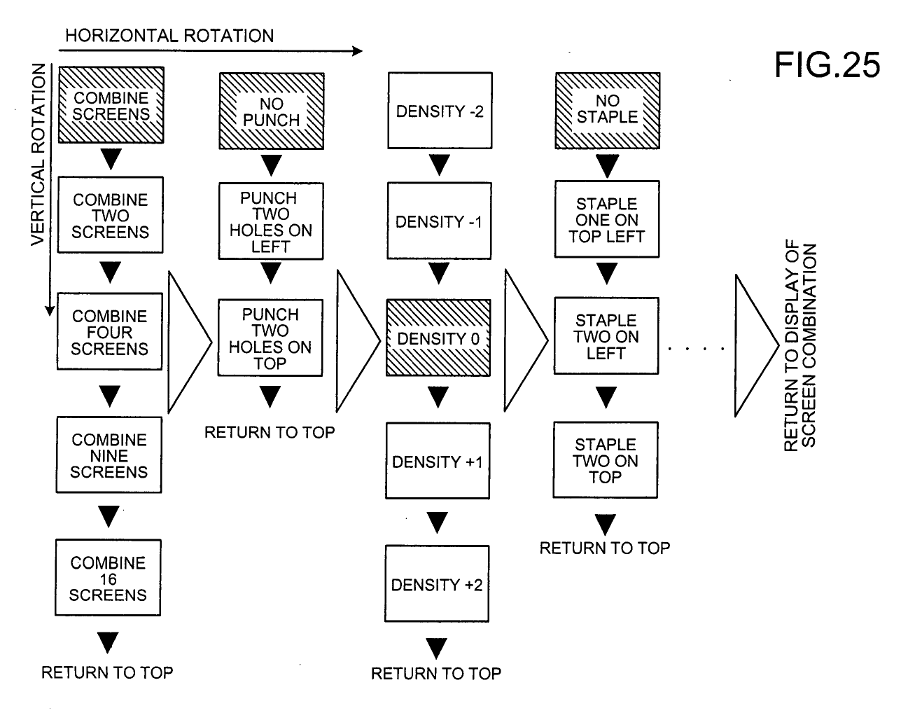

FIG. 25 is an explanatory diagram of a shift of condition information to be displayed in a block on the preview and detail setting screen by the condition-display processing unit 2121 according to the second embodiment. As shown in FIG. 25, the condition-display processing unit 2121 displays different condition information of the same item as that of before rotation in the block, after the rotating unit 2102 controls rotation and shift of the virtual cube vertically by using the second axis of rotation. Specifically, every time the rotating unit 2102 controls rotation and shift in the rotation direction described above, the condition-display processing unit 2121 displays condition information by changing it from “Screen combination” to “Combine two screens”, “Combine four screens”, or the like in the block. The setting receiving unit 402 receives the setting condition according to the displayed condition information after display of rotation and shift vertically.

When the rotating unit 2102 controls rotation of the virtual cube horizontally by using the first axis of rotation, the condition-display processing unit 2121 displays information of an item different from that of before rotation in the block. Specifically, when “Screen combination” is displayed in the block before rotation, the condition-display processing unit 2121 displays condition information by changing it to “No punch”, “Density 0”, or the like. When changing the item on a display rotated and shifted horizontally, the condition-display processing unit 2121 displays the condition information according to a condition received as setting of the item. When the user has not yet set the setting condition for each item, the condition-display processing unit 2121 displays condition information according to a predetermined setting condition. In FIG. 25, the face expressing condition information according to the predetermined setting condition is referred to as a hatched face. In other words, in a state where the user has not yet set the setting condition for each item, the condition-display processing unit 2121 sequentially displays in the block “Screen combination”, “No punch”, “Density 0”, and “No staple”, every time the virtual cube is rotated and shifted in a direction of white arrow in FIG. 25. When rotation and shift in the same direction are performed, the condition-display processing unit 2121 displays “Combine screens” again after items have come round.

The face of the virtual cube expressing the condition information dynamically changed and displayed in the block by the condition-display processing unit 2121 after the rotating unit 2102 controls rotation of the virtual cube is explained. For example, at the time of displaying a face expressing “Combine screens” first, when the condition-display processing unit 2121 displays rotation and shift of the virtual cube four times in one direction about the second axis of rotation, the original face is arranged in the block, although a face expressing “Combine 16 screens” is displayed in the block. Thus, the condition-display processing unit 2121 dynamically changes and displays the condition information expressed on the face of the virtual polyhedron corresponding to the settable number of conditions for each item. Accordingly, the number of setting conditions settable for each item can be flexibly set, regardless of the number of faces of the virtual polyhedron provided in the block. Further, the same applies to a case of rotating the virtual polyhedron horizontally, and the number of items can be flexibly set regardless of the number of faces of the virtual polyhedron.

At the time of controlling rotation of the virtual polyhedron horizontally to change the item to be displayed by the rotating unit 2102, when having received the setting condition of the changed item from the user, the condition-display processing unit 2121 displays a face expressing the condition information according to the received setting condition in the block after rotation and shift. In other words, the condition-display processing unit 2121 sequentially displays the condition information according to the predetermined setting condition, in the state where the setting condition has not yet been received. When having received the setting condition of an optional item, the condition-display processing unit 2121 displays the condition information according to the received setting condition. For example, when the user rotates the virtual polyhedron to change display from “Density 0” to “Density +2”, while it does not change the condition information of other items, the rotating unit 2102 controls rotation of the virtual cube horizontally, and the condition-display processing unit 2121 sequentially displays “Combine screens”, “No punch”, “Density +2”, and “No staple” in the block. Accordingly, when the rotating unit 2102 controls rotation of the virtual polyhedron horizontally, the condition-display processing unit 2121 changes the condition information to be dynamically displayed based on the received setting condition.

In other words, the condition information according to the setting condition currently received for a different item is displayed, every time when the rotating unit 2102 controls rotation of the virtual polyhedron horizontally. Further, every time when the rotating unit 2102 controls rotation of the virtual polyhedron vertically, the condition-display processing unit 2121 displays different condition information of the same item, and a condition according to the displayed condition information is newly received as a setting.

Since the condition-display processing unit 2121 performs such display, every time when the rotating unit 2102 controls rotation horizontally, the condition-display processing unit 2121 displays condition information according to the currently received setting condition. That is, the user can recognize what type of setting condition is set for each item. In FIG. 25, since triangles are used as arrows indicating the horizontal and vertical directions, it seems that rotation in only one direction is possible. However, this is for facilitating explanation with reference to FIG. 25, and rotation of the virtual polyhedron can be controlled in the opposite direction, as descried above.

Returning to FIG. 22, the input receiving unit 2103 includes an item adding unit 2111, an item deleting unit 2112, and an item changing unit 2113, and receives input to the operation panel 300 by the user. Specifically, the input receiving unit 2103 receives an input from the LCD touch panel 320, the ten key 306, and the like as in the input receiving unit 406, and outputs this matter to the rotating unit 2102 or the setting receiving unit 402.

In the MFP 2100 according to the second embodiment, the number of items and condition information can be set, regardless of the number of the faces of the virtual polyhedron in the block to be displayed on the preview and detail setting screen. Therefore, the seller can add, delete, and change the items to be displayed in the block in response to a request from the user. The item adding unit 2111, the item deleting unit 2112, and the item changing unit 2113 can display an appropriate item in response to a request from the user as in the area adding unit 421, the area deleting unit 422, and the area changing unit 423 according to the first embodiment.

The item adding unit 2111 adds a newly settable item in the block on the preview and detail setting screen. When an item is added by the item adding unit 2111, and when the virtual polyhedron is rotated horizontally in the block on the preview and detail setting screen, a face expressing condition information of the added item is displayed. That is, the seller can add an item to be displayed in the block in response to a request from the user, and the convenience of the apparatus is improved accordingly.

The item deleting unit 2112 deletes one item in the block on the preview and detail setting screen. When an item is deleted by the item deleting unit 2112, the condition information of the deleted item is not displayed on the preview and detail setting screen. That is, the seller can delete items for each function in response to a request from the user, and the convenience of the apparatus is improved accordingly.

The item changing unit 2113 changes the order of items expressed on the face, when the virtual polyhedron is rotated horizontally in a block on the preview and detail setting screen. That is, the seller can change the order of items in response to a request from the user, and the convenience of the apparatus is improved accordingly.

In the above explanation, while only addition, deletion, and change of items have been explained, addition, deletion, and change of condition information for an item can be also performed in a similar procedure.

An addition of an item by the item adding unit 2111 is explained for the case shown in FIG. 25. The item adding unit 2111 newly adds an item of digital watermark between an item of screen combination and an item of punch. After the addition, when the rotating unit 2102 rotates the virtual polyhedron horizontally, the condition-display processing unit 2121 sequentially displays “Combine screens”, “Digital watermark”, and “No punch” in the block.

An example of a case that the order for displaying items is changed by the item changing unit 2113 is explained. In FIG. 25, when the rotating unit 2102 rotates the virtual polyhedron horizontally, the condition-display processing unit 2121 displays in order of “Combine screens”, “No punch”, and “Density −2” in the block. In this case, after the item changing unit 2113 has changed the order of items, the condition-display processing unit 2121 can display in order of “Combine screens”, “Density 0”, and “No punch”.

The process procedure from an initial display on the function selecting screen performed by the MFP 2100 according to the second embodiment up to a display of the function selecting screen after having received function selection is the same as the process procedure according to the first embodiment, except that an item displayed in the block is changed over by rotating the virtual polyhedron horizontally. Therefore, explanation thereof is omitted.

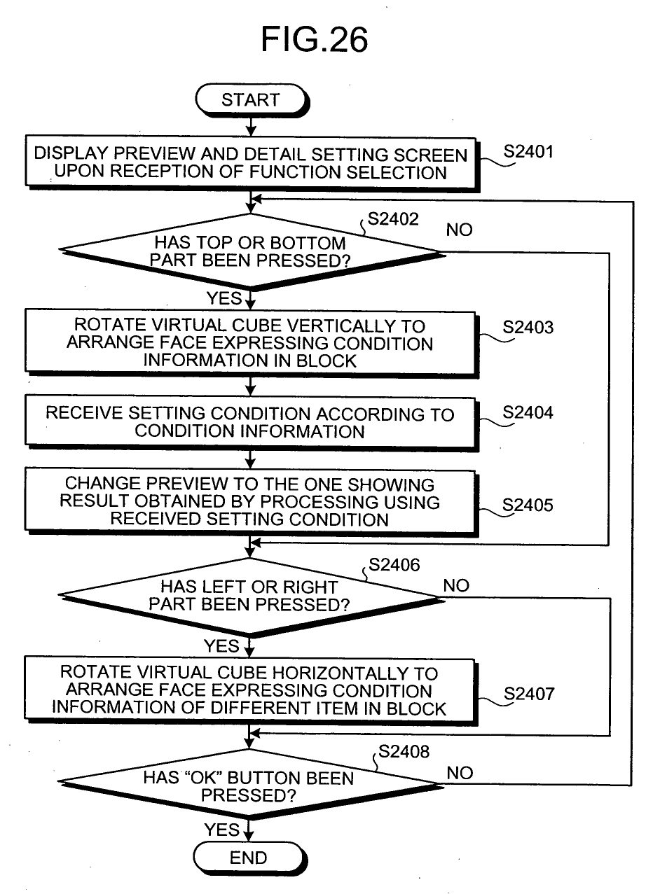

A process procedure at the time of displaying the preview and detail setting screen in the MFP 2100 according to the second embodiment is explained next. FIG. 26 is a flowchart of the process procedure in the MFP 2100 according to the second embodiment.

First, upon reception of function selection on the function selecting screen, the condition-display processing unit 2121 displays the preview and detail setting screen (step S2401). For example, in a case that the input function has been already selected, upon reception of selection of the output function, the condition-display processing unit 2121 displays a result of output by using the input image data under a predetermined setting condition in a preview.

The input receiving unit 2103 then detects whether an top or bottom region of the block displayed on the preview and detail setting screen has been pressed (step S2402). When pressing of the top or bottom region has not been detected (step S2402: No), no particular process is performed.

When the input receiving unit 2103 detects pressing of the top or bottom region of the block (step S2402: Yes), the rotating unit 2102 rotates the virtual polyhedron provided in the block vertically about the second rotation axis, and the condition-display processing unit 2121 displays a face expressing different condition information set for the same item as that of before the rotation in the block (step S2403).

The setting receiving unit 402 then receives a setting condition according to the condition information displayed in the block (step S2404). The preview-display processing unit 443 displays a preview indicating a result summary of processing by using the received setting condition, in the preview on the preview and detail setting screen (step S2405).

The input receiving unit 2103 then detects whether a left or right region of the block has been pressed (step S2406). When pressing of the left or right region has not been detected (step S2406: No), no particular process is performed.

When the input receiving unit 2103 detects pressing of the left or right region of the block (step S2406: Yes), the rotating unit 2102 rotates the virtual polyhedron provided in the block horizontally, and the condition-display processing unit 2121 displays a face expressing condition information of a different item as that of before the rotation in the block (step S2407).

The input receiving unit 2103 then detects whether the “OK” button has been pressed (step S2408). When pressing of the “OK” button has not been detected, the input receiving unit 2103 then detects whether the top or bottom region of the block has been pressed (Step S2402).

Upon detection of pressing of the “OK” button (step S2408: Yes), the input receiving unit 2103 determines that setting of the function has finished, to finish the display of the preview and detail setting screen. The 3D-display processing unit 441 then displays the function selecting screen.

According to the above process procedure, setting conditions of a plurality of items can be received in one block displayed on the preview and detail setting screen in the second embodiment. The process procedure indicates an example at the time of displaying the preview and detail setting screen according to the second embodiment, and the present invention is not limited thereto.

The shapes of the face of the virtual polyhedron and the block displayed on the LCD touch panel 320 of the MFP 2100 in the second embodiment are not limited to the rectangular shape, and for example, any shape such as a hexagonal shape can be used.

The virtual polyhedron used in the MFP 2100 in the second embodiment uses two orthogonal rotation axes. However, the rotation axis is not limited thereto, so long as rotation in biaxial directions is possible.

Furthermore, the number of rotation axes for rotating the virtual polyhedron can be more than two.

Since the MFP 2100 in the second embodiment displays faces of the virtual polyhedron rotatable about a plurality of rotation axes as a block on the LCD touch panel 320, a setting condition can be set for a plurality of items in one block. That is, an area for receiving setting does not need to be prepared for each item. Accordingly, the displayable area of the LCD touch panel 320 can be effectively used.

In the MFP 2100 in the second embodiment, a plurality of rotation axes is provided in one block. As a result, at the time of rotating the virtual polyhedron, if the virtual polyhedron is rotated by using one of the rotation axes, items to be displayed is changed. If the virtual polyhedron is rotated by using the other rotation axes, a setting condition different from that of before the rotation can be received for the same item as that of before the rotation.

Since the face is rotated and shifted, the user can recognize that items and condition information are expressed on the faces of the virtual polyhedron, and can easily recognize the order of display of items and condition information on the virtual polyhedron. Accordingly, the operability and visibility at the time of setting the setting condition for each item in the MFP 2100 are improved.

Further, the condition information expressed on the face of the virtual polyhedron provided in the block on the preview and detail setting screen of the MFP 2100 in the second embodiment is dynamically changed and displayed corresponding to the rotation direction. As a result, the number of items and the number of condition information displayed in the block are not limited to the number of faces of the virtual polyhedron. In other words, since all items and condition information required for the user can be displayed, the convenience is improved. Further, since the virtual polyhedron suitable for the number of items and the number of condition information to be displayed does not need to be prepared, development of the apparatus is facilitated.

The apparatus that rotates the virtual polyhedron about a plurality of rotation axes and displays the virtual polyhedron in one block shown in the second embodiment is not limited to the MFP, and any apparatus can be used.

### First Modification Example of Second Embodiment

In the second embodiment, only one face of the virtual polyhedron is displayed in the block displayed on the preview and detail setting screen. However, the face arranged in the block is not limited to such an arrangement. In a first modification example of the second embodiment, therefore, a case that a part of the top and bottom, and left and right faces is displayed, centering on one face of the virtual polyhedron, in the block displayed on the preview and detail setting screen is explained. Accordingly, a virtual polyhedron, in which a part of the top and bottom, and left and right faces can be seen, centering on one face of the virtual polyhedron, is used as the virtual polyhedron in the first modification example of the second embodiment.

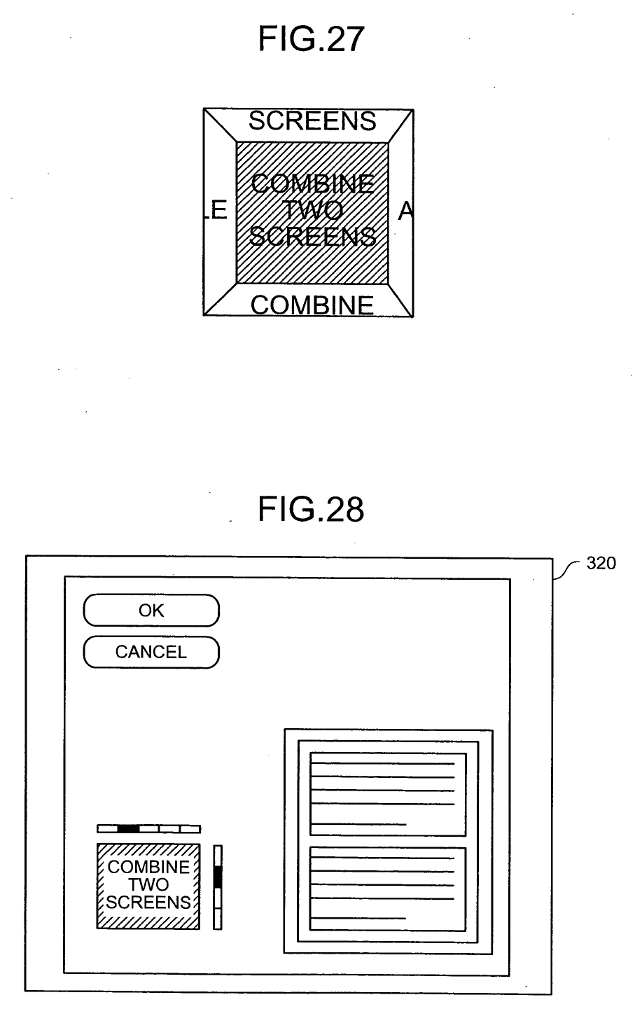

FIG. 27 is an explanatory diagram of an example of the block displayed on the LCD touch panel 320 in the first modification example. The condition-display processing unit in the first modification example displays a part of adjacent faces in the top, bottom, left, and right directions, centering on one face, in the block on the preview and detail setting screen. As a result, the user can recognize condition information to be displayed at the time of rotating the virtual polyhedron provided in the block. In other words, since the user can recognize the item and condition information to be displayed next, convenience at the time of searching a desired item and condition information is improved.

### Second Modification Example of Second Embodiment

In the second embodiment, the display of the virtual polyhedron is not limited to the face arranged in the block. For example, such a display can be performed that the user can recognize the position of the currently displayed condition information and settable setting condition, or the number of items. In a second modification example of the second embodiment, therefore, a case is explained where a bar for indicating the position of condition information currently displayed in the same item and the number thereof, and a bar for indicating the position of the currently displayed item and the number of settable items are displayed.

FIG. 28 is an example of the preview and detail setting screen displayed by the condition-display processing unit according to the second modification example. On this screen, bars are arranged above and on the right side of the block. The upper bar indicates the current position of the currently displayed item of all settable items. The right bar indicates the current position of currently displayed condition information of all the settable condition information for the currently displayed items.

In the second modification example, by displaying these bars, the user can recognize the number of settable items, the position of the currently displayed item, the number of condition information settable for each item, and the position of the currently displayed condition information. The convenience at the time of operation by the user is improved accordingly.

In the second modification example, the bar is used for displaying the overall amount and the current position according to the number of items or condition information. However, various modes such as displaying the side geometry of the virtual polyhedron can be made, as in the modification example of the first embodiment.

### Third Embodiment

In the above embodiments, the MFP that executes the function of the display processing apparatus has been explained; however, the display processing apparatus is not limited to the MFP. In a third embodiment of the present invention, therefore, a case that a display processing apparatus 2800 is used is explained.

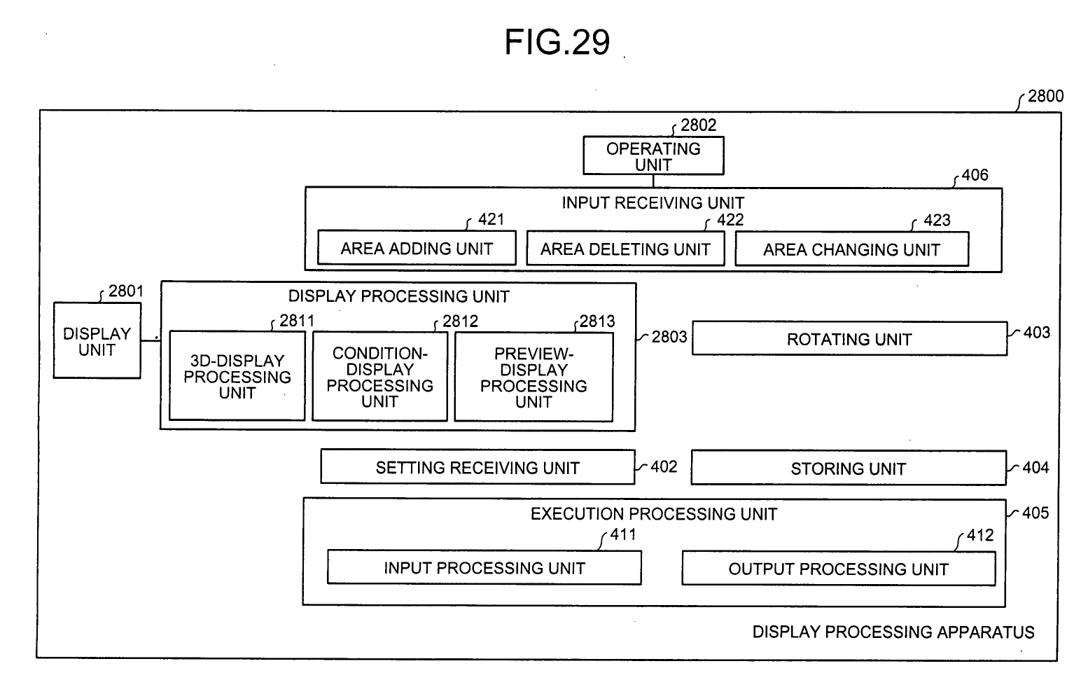

FIG. 29 is a functional block diagram of the display processing apparatus 2800 according to the third embodiment. The display processing apparatus 2800 has substantially the same configuration as that of the application layer 451 of the MFP 1 according to the first embodiment, except that the display processing unit 401 is changed to a display processing unit 2803, and a display unit 2801 and an operating unit 2802 are added, as shown in FIG. 29. Further, the display processing apparatus 2800 includes the storing unit 404 therein, which is provided outside of the application layer 451 in the above embodiments. In the explanation below, like reference numerals refer to like parts according to the first embodiment, and explanation thereof is omitted.

The display processing unit 2803 includes a 3D-display processing unit 2811, a condition-display processing unit 2812, and a preview-display processing unit 2813.

The 3D-display processing unit 2811 is different from the 3D-display processing unit 441 in the above embodiments in that it displays a face expressing a different function, corresponding to a difference in the executable functions of the MFP 1 and the display processing apparatus 2800. Other points are the same as in the 3D-display processing unit 441, and hence explanation thereof is omitted. The 3D-display processing unit 2811 can express a plurality of input functions and a plurality of output functions for each face as in the above embodiments, or can express a function irrelevant to input and output for each face.

When the setting receiving unit 402 receives a function from a virtual cube displayed by the 3D-display processing unit 2811, the condition-display processing unit 2812 displays a block on the preview and detail setting screen for setting the function. In the third embodiment, the condition-display processing unit 2812 displays a plurality of blocks for each of the settable items corresponding to the function received by the setting receiving unit 402. Other points are the same as in the condition-display processing unit 442, and hence explanation thereof is omitted. The condition-display processing unit 2812 can display settable items collectively in one block as in the second embodiment.

The vertical cube on which a plurality of faces expressing a function are arranged by the 3D-display processing unit 2811, the preview and detail setting screen by the condition-display processing unit 2812, and the like are displayed on the display unit 2801.

The display unit 2801 can be, for example, a liquid crystal panel or the like built in the display processing apparatus 2800. This liquid crystal panel does not need to be the LCD touch panel inputtable by the user by touch input. The liquid crystal panel can receive an input from the operating unit 2802 equipped separately from the LCD touch panel by the input receiving unit 406. It is assumed that the display unit 2801 is provided beforehand in the display processing apparatus 2800, and includes a display area of a predetermined size.

Although different from the third embodiment, the display unit can be the LCD touch panel as in the above embodiments, and the functions of the display unit and the operating unit can be integrated.

Although the predetermined size of the display area of the display unit 2801 is not limited, it is desired that the size thereof is smaller than the display processing apparatus 2800, since it is equipped in the display processing apparatus 2800. In the third embodiment, the size of the display area of the display unit 2801 is a size designed so that the user can recognize the executable functions.

The display processing apparatus 2800 including the display unit 2801 of the size designed so that the user can recognize the executable functions can be various types of apparatus including the display unit 2801 of the size necessary and sufficient for displaying the functions, and designed, giving priority to the portability, space saving, or other functions over the size of the display unit. For example, the display processing apparatus 2800 can be an image forming apparatus, audio visual (AV) equipment, portable terminal, mobile phone, or the like.

The display unit including the size designed so that the user can recognize the executable functions excludes a display such as a PC having high generality and designed without assuming a state where the functions are actually displayed, for which there is a plurality of different sizes, although the same functions are displayed. This is because when a screen layout for displaying the functions on the PC or the like is designed, the display area of the displays already put on the market is generally taken into consideration. In other words, the display is a main determination material, which is different from the above apparatus in that the size of the display is not changed according to the functions to be displayed.

The operating unit 2802 is an interface provided for the user to perform an operation with respect to the display processing apparatus 2800. The operating unit 2802 can be any mechanism, so long as it is an interface, by which the user can input selection, at the time of selecting a face expressing the function.

The apparatus including the display processing apparatus 2800 according to the third embodiment built therein includes AV equipment capable of storing, for example, music data and performing output to another equipment or reproduction. That is, any apparatus can be used so long as it is an apparatus including a plurality of functions, being capable of display on a display unit such as the liquid crystal panel included in the apparatus, and including a LCD touch panel for selecting a function or an interface including a plurality of buttons or the like.

As another example, the display processing apparatus 2800 according to the third embodiment can be built in a car navigation apparatus.

The display processing apparatus 2800 according to the third embodiment can be also built in an apparatus including a display unit including a necessary and sufficient size for allowing the user to recognize the functions and an interface, and carried by the user. For example, a portable terminal including a LCD touch panel such as a personal digital assistant (PDA) can be considered.

The display processing apparatus 2800 according to the third embodiment can be applied to a mobile phone and the like. As an example using the mobile phone, there is a case that a built-in program is activated, and a virtual polyhedron having a plurality of faces expressing functions for performing some processes is displayed, to receive selection of the face. In this case, as in the above embodiments, control for rotating the virtual polyhedron holding the faces expressing condition information on a display screen of the mobile phone is performed when the input receiving unit 406 receives a predetermined input. As a result, even if the area that can be used for displaying condition information for each item is small, the number of condition information is not limited according to the display area by rotating and shifting the faces of the virtual polyhedron expressing the condition information, and condition information, for which setting has been received, can be displayed. Accordingly, even when a plurality of pieces of condition information is held, a setting condition according to appropriate condition information can be set.

As an example of receiving a selection of a face expressing a function in the case of a mobile phone, selection of a block and a setting condition according to condition information can be received by pressing a dial button in which top, bottom, left, and right regions are allocated. For example, upon reception of pressing of a button where “left and right regions” are allocated, the selected block is changed, and upon reception of pressing of a button where “top and bottom regions” are allocated, the virtual polyhedron provided in the selected block is rotated, to receive the setting condition according to the condition information after the rotation. Thus, even by a standard interface included in the mobile phone, an item desired by the user and a setting condition for each item can be accepted.

Furthermore, the display processing apparatus 2800 is not limited to the one built in another apparatus, and for example, can be the one in which the function of the display processing apparatus 2800 is realized by activating the program by the mobile phone or the like. Even by such a mobile phone, by displaying a block on the display and rotating a virtual polyhedron provided in the block, condition information expressed on the face arranged in the block is changed, and by receiving a setting condition according to the changed condition information, the same effect as that of the embodiments described above can be obtained.

The same applies to a portable game terminal or the like. Thus, even by an apparatus in which the display unit and the interface are not substantial as compared to the PC and the like, the setting condition can be easily set, thereby improving the operability.

A touch panel can be used for the operating unit of the display processing apparatus. For example, an apparatus including the touch panel displays a block on the display unit, and when detecting that the user presses the block on the touch panel, the apparatus rotates the virtual polyhedron provided in the block, to display rotation and shift of the face of the virtual polyhedron. Thus, even in the case of an apparatus whose input interface is limited, by displaying the block, and rotating the virtual cube provided in the block, to change over and display condition information expressed on the face of the virtual polyhedron, the setting condition according to the condition information can be received, thereby improving the operability.

Although different from the third embodiment, the present invention can be also applied to an apparatus including an input unit of a coordinate input type such as a LCD touch panel or a tablet. For example, in an apparatus connected to a tablet and a monitor, a block is displayed on the monitor. The user instructs a region corresponding to the block from the tablet by using a stylus pen, to control the rotation of the virtual polyhedron provided in the block. After rotation and shift of the face of the virtual polyhedron is displayed, the setting receiving unit receives a setting condition according to the condition information displayed on the face of the virtual polyhedron provided in the block. Thus, when the input interface is limited, a virtual polyhedron is arranged in the block, and the setting condition according to the condition information expressed on the displayed face is received, thereby facilitating setting of the condition and improving the operability.

The display processing program executed by the MFP indicated in the above embodiments and modification examples is stored in the ROM or the like beforehand and provided to users.

The display processing program executed by the MFP according to the embodiments can be recorded on a computer readable recording medium such as CD-ROM, flexible disk (FD), CD-R, digital versatile disk (DVD) and offered in an installable or executable file format.

The display processing program executed by the MFP according to the embodiments can be stored on a computer connected to a network such as the Internet, and provided by downloading the program via the network. Further, the display processing program can be provided or distributed via the network such as the Internet.

The display processing program executed by the MFP according to the embodiments has a module configuration including the respective units (display processing unit, setting receiving unit, rotating unit, execution processing unit, and input receiving unit). As actual hardware, the CPU (processor) reads the display processing program from the ROM and executes the program, so that the respective units are loaded on a main memory, to generate the display processing unit, the setting receiving unit, the rotating unit, the execution processing unit, and the input receiving unit on the main memory.

According to an embodiment of the present invention, when a rotation instruction is received from a user, due to rotation and shift of the condition specifying area, a setting condition according to condition information displayed in the next condition specifying area expressed in a predetermined area is received. Therefore, the condition can be easily set according to a request from a user.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display processing apparatus comprising:
a condition-display processing unit that displays, in a predetermined display area, a condition specifying area in which condition information indicating a setting condition is displayed; and
a rotating unit that rotates, when a rotation instruction is received from a user, the condition specifying area displayed by the condition-display processing unit, and rotates a next condition specifying area to the predetermined display area.

2. The display processing apparatus according to claim 1, further comprising:
a setting receiving unit that receives a setting condition for condition information displayed in the next condition specifying area rotated to the predetermined display area by the rotating unit.

3. The display processing apparatus according to claim 1, further comprising:
a display unit that has a displayable coordinate input screen, and receives an instruction from a touch input on the coordinate input screen, wherein
the condition-display processing unit displays the condition specifying area in a predetermined display area on the coordinate input screen of the display unit, and the rotating unit rotates, when a rotation instruction is received from the coordinate input screen of the display unit, the condition specifying area displayed by the condition-display processing unit, and rotates the next condition specifying area to the predetermined display area on the coordinate input screen of the display unit.

4. The display processing apparatus according to claim 1, further comprising:
a display unit including a display area of a predetermined size that is set for a purpose of making the user be able to recognize an executable function, wherein
the condition-display processing unit displays the condition specifying area in a predetermined display area on the display unit.

5. The display processing apparatus according to claim 1, wherein
the rotating unit can rotate the condition specifying area displayed by the condition-display processing unit to different directions with different angles, and
when a rotation instruction to any one of the different directions is received from the user, the rotating unit rotates the condition specifying area in a direction instructed by the user, and rotates the next condition specifying area to the predetermined display area in the instructed direction.

6. The display processing apparatus according to claim 5, wherein
when a rotation instruction to one direction of the different directions is received from the user, the rotating unit rotates the condition specifying area in the one direction, and rotates the next condition specifying area in which condition information for an item different from an item in the condition specifying area is displayed to the predetermined area in the one direction, or
when a rotation instruction to other direction of the different directions is received from the user, the rotating unit rotates the condition specifying area in the other direction, and rotates the next condition specifying area in which different condition information of a same item as that in the condition specifying area is displayed to the predetermined area in the other direction.

7. The display processing apparatus according to claim 1, wherein
the condition-display processing unit displays a plurality of condition specifying areas different for each item in a predetermined area provided in each condition specifying area.

8. The display processing apparatus according to claim 1, wherein
the rotating unit rotates the condition specifying area displayed by the condition-display processing unit in one direction or in a direction opposite to the one direction, and rotates the next condition specifying area to the predetermined display area in a same direction.

9. The display processing apparatus according to claim 8, wherein
when an instruction to make a rotation direction determined by an area pressed by a user be one direction or a direction opposite to the one direction, the rotating unit rotates the condition specifying area displayed by the condition-display processing unit in an instructed direction, and rotates the next condition specifying area to the predetermined display area in the instructed direction.

10. A display processing method comprising:
displaying, in a predetermined display area, a condition specifying area in which condition information indicating a setting condition is displayed; and
area rotating including rotating, when a rotation instruction is received from a user, the condition specifying area displayed at the displaying; and
rotating a next condition specifying area to the predetermined display area.

11. The display processing method according to claim 10, further comprising:
receiving a setting condition for condition information displayed in the next condition specifying area rotated to the predetermined display area at the area rotating.

12. The display processing method according to claim 10, further comprising:
receiving an instruction from a touch input on a coordinate input screen of a display unit, wherein
the displaying includes displaying the condition specifying area in a predetermined display area on the coordinate input screen of the display unit, and
the area rotating includes
rotating, when a rotation instruction is received from the coordinate input screen of the display unit, the condition specifying area displayed at the displaying; and
rotating the next condition specifying area to the predetermined display area on the coordinate input screen of the display unit.

13. The display processing method according to claim 10, wherein
the displaying includes displaying the condition specifying area in a predetermined display area on a display unit including a display area of a predetermined size that is set for a purpose of making the user be able to recognize an executable function.

14. The display processing method according to claim 10, wherein
the condition specifying area displayed at the displaying can be rotated to different directions with different angles, and
when a rotation instruction to any one of the different directions is received from the user, the area rotating includes rotating the condition specifying area in a direction instructed by the user; and
rotating the next condition specifying area to the predetermined display area in the instructed direction.

15. The display processing method according to claim 14, wherein
when a rotation instruction to one direction of the different directions is received from the user, the area rotating includes
rotating the condition specifying area in the one direction; and
rotating the next condition specifying area in which condition information for an item different from an item in the condition specifying area is displayed to the predetermined area in the one direction, or
when a rotation instruction to other direction of the different directions is received from the user, the area rotating includes
rotating the condition specifying area in the other direction; and
rotating the next condition specifying area in which different condition information of a same item as that in the condition specifying area is displayed to the predetermined area in the other direction.

16. The display processing method according to claim 10, wherein
the displaying includes displaying a plurality of condition specifying areas different for each item in a predetermined area provided in each condition specifying area.

17. The display processing method according to claim 10, wherein
the area rotating includes
rotating the condition specifying area displayed at the displaying in one direction or in a direction opposite to the one direction; and
rotating the next condition specifying area to the predetermined display area in a same direction.

18. The display processing method according to claim 17, wherein
when an instruction to make a rotation direction determined by an area pressed by a user be one direction or a direction opposite to the one direction, the area rotating includes
rotating the condition specifying area displayed at the displaying in an instructed direction; and
rotating the next condition specifying area to the predetermined display area in the instructed direction.

19. A computer-readable recording medium that stores therein a computer program that causes a computer to execute:
displaying, in a predetermined display area, a condition specifying area in which condition information indicating a setting condition is displayed; and
area rotating including
rotating, when a rotation instruction is received from a user, the condition specifying area displayed at the displaying; and
rotating a next condition specifying area to the predetermined display area.

20. The computer-readable recording medium according to claim 19, wherein
the condition specifying area displayed at the displaying can be rotated to different directions with different angles, and
when a rotation instruction to any one of the different directions is received from the user, the area rotating includes
rotating the condition specifying area in a direction instructed by the user; and
rotating the next condition specifying area to the predetermined display area in the instructed direction.
